(19) United States
(12) Patent Application Publication
(10) Pub. No.: US 2026/0194873 A1
(43) Pub. Date: Jul. 9, 2026

(54) System and Method of Grid-Forming Hamiltonian Control in IBR-Rich Grids Enabling Scalability, Stability, and Passivity

(71) Applicant: The Research Foundation for The State University of New York, Albany, NY (US)

(72) Inventors: Peng ZHANG, Jericho, NY (US); Qing SHEN, Canton, MA (US); Yacov A. SHAMASH, Westbury, NY (US)

(21) Appl. No.: 19/554,797

(22) Filed: Mar. 3, 2026

Related U.S. Application Data
(63) Continuation-in-part of application No. 19/068,194, filed on Mar. 3, 2025.
(60) Provisional application No. 63/561,089, filed on Mar. 4, 2024.

(51) Int. Cl. G05B 13/04; H02J 3/38; H02J 103/30

(52) U.S. Cl. CPC G05B 13/042; H02J 3/381; H02J 2103/30

(57) ABSTRACT

System and method of controlling an IBR on a power network, including: receiving as input measured input power parameters for a current time step and an input system state calculated for a previous time step, wherein the input system state is simulated or measured for a first time step; processing the input power parameters and the input system state using a neural Port-Hamiltonian controller, including trained neural networks with an embedded Lyapunov function which includes physical constraints of the power network, to generate prediction outputs including a Hamiltonian function, several structure matrices, and a neural secondary control; and executing the Lyapunov function based on the Hamiltonian function and the neural secondary control that satisfies the physical constraints, wherein the IBR is capable of being controlled using an output secondary control based at least on the neural secondary control, ensuring passivity and stability of the power network.

### CROSS-REFERENCE TO RELATED APPLICATIONS

This application is a continuation-in part of U.S. patent application Ser. No. 19/068,194, filed on Mar. 3, 2025, which claims priority to U.S. Provisional Patent Application No. 63/561,089, filed on Mar. 4, 2024, the contents of all of which are incorporated herein by reference.

### STATEMENT OF GOVERNMENT RIGHTS

This invention was made with government support under OIA2134840 and OIA2040599 awarded by the National Science Foundation. The government has certain rights in the invention.

### BACKGROUND

### Field

The present application relates control of inverter-based resources on power grids. More specifically, the present application is directed to a system and method of grid-forming Hamiltonian control in IBR-rich grids enabling scalability, stability, and passivity.

### Brief Discussion of Related Art

An inverter-based resource (“IBR”) of a power grid, such as a microgrid, is an energy source or storage device that is connected to the grid via an inverter rather than a traditional generator, including IBRs such as solar, wind, and battery storage devices. Unlike a traditional generator, an IBR lacks intrinsic inertia and is typically controlled by an algorithm in order to convert direct current (DC) to alternating current (AC) for grid transmission.

The growing complexity, nonlinearities, and dynamic nature of modern power grids, exemplified by microgrids and power systems interconnected with IBRs, have made control approaches increasingly challenging. The strongly nonlinear dynamics of IBRs and their reduced inertia can significantly deteriorate stability of a system. Uncertainties introduced by renewable energy sources as well as renewable-enabling energy sources (e.g., solar, wind, storage, etc.) further impact IBR operation and may drive the system toward unstable operating states. Therefore, scalability and plug-and-play capabilities are essential for the ever-evolving grid edges, particularly characterized by increasing integration of IBRs and microgrids.

Existing model-driven control methodologies, including linearization-based and Lyapunov function-based approaches, struggle to handle unforeseen large disturbances and uncertain scenarios. As complexity of the system increases, deriving closed-form analytical solutions becomes non-trivial and, in many cases, not feasible. As a result, these control methodologies cannot consistently guarantee passivity and stability when an ever-greater number of IBRs and microgrids are integrated and further when operating conditions of the system change. These limitations become increasingly critical as the grid or microgrid evolves, requiring more dynamic and adaptable control strategies.

A Port-Hamiltonian (“PH”) system (“PHS”) is particularly attractive because of its compositional property, where integrating a passive subsystem into an existing passive system preserves overall passivity. This structure-preserving nature enables localized learning and plug-and-play integration into composite models. Moreover, a Hamiltonian function provides a physically interpretable energy representation to construct Lyapunov functions, thus enabling stability analysis and control design. Existing works on PH systems establish generalized modelling and control frameworks that ensure controlled converters remain passive and input-to-state stable. However, their scope is largely confined to small-scale systems, and analytical derivations required by classical control techniques become intractable for large-scale or highly nonlinear systems. Recent advances suggest that these derivations can be significantly streamlined using physics-informed machine learning.

Neural Hamiltonian approaches provide a promising solution by leveraging neural networks to construct Hamiltonian functions for modelling and solving differential equations. Originally introduced to enforce exact conservation laws in an unsupervised manner, Hamiltonian Neural Networks (“HNNs”) are now recognized as a representative class of physics-informed learning methods. They have been successfully applied to nonlinear oscillators and chaotic systems, and they have been adapted to power systems for predicting transient trajectories and dynamic parameters. However, such adaptations have been limited to small, unforced, single-machine systems where the Hamiltonian function already has an analytical solution, whereas direct analytical derivations can be infeasible for larger, forced, and networked power systems. Compositional Port-HNNs further extended their capability, preserving key PHS properties like cyclo-passivity, which is beneficial for control applications.

Despite the foregoing foundational contributions, in the context of power systems, to date no work has proposed a neural PHS linked to Lyapunov functions and stability analysis. This gap highlights a significant need for a framework that unifies distributed physics-informed learning, provable stability guarantees, and efficient, scalable IBR integration for power systems in power grids and microgrids.

It is therefore desirable to devise a grid-forming Port-Hamiltonian methodology (GFM^{H}) controller that is capable of independently providing a secondary control to an IBR controller (e.g., droop controller) for controlling one or more IBRs on a power grid or microgrid using neural PHS framework and methodology coupled with Lyapunov certified control policies, as well as a composite controller that integrates control of the neural GFM^{H} controller with control of a baseline GMF controller, for providing a composite secondary control to the IBR controller for controlling the one or more IBRs, the foregoing enabling scalability, passivity, and stability of the IBRs on the grid or microgrid.

### SUMMARY

In accordance with an embodiment, there is disclosed a system to control an inverter-based resource (IBR) on a power distribution network, wherein the system includes a processing device and a memory storing instructions that, when executed by the processing device, perform the following operations.

In particular, the operations of the system include: receiving as input measured input power parameters for a current time step and input system state related to the IBR as calculated for a previous time step, wherein the input system state is simulated or measured when the current time step is a first time step and there is no previous time step; processing the input power parameters and the input system state using a neural Port-Hamiltonian controller, including trained neural networks with an embedded Lyapunov function which includes physical constraints of the power distribution network, to generate prediction outputs including a Hamiltonian function, several structure matrices, and a neural secondary control; and executing the Lyapunov function based on the Hamiltonian function and the neural secondary control that satisfies the physical constraints, wherein the IBR is capable of being controlled using an output secondary control based at least on the neural secondary control, ensuring passivity and stability of the power distribution network.

The operations of the system can further include transmitting the neural secondary control as the output secondary control to an IBR controller, the IBR controller being configured to control the IBR based on a primary control generated by the IBR controller and the neural secondary control.

The operations of the system can further include: optimizing the neural secondary control to an optimized neural secondary control; and transmitting the optimized neural secondary control as the output secondary control to an BR controller, the IBR controller being configured to control the IBR based on a primary control generated by the IBR controller and the optimized neural secondary control. In some cases, the neural secondary control can be optimized using Gurobi optimization to form the optimized neural secondary control.

The operations can further include: generating a derivative of system dynamics for the current time step based on the prediction outputs; and integrating the derivative to generate an output system state to be used as the input for a next time step. The operations can further include iterating receiving, processing, and executing for the next time step.

The operations of the system can further include: processing the input power parameters using a baseline controller to generate a baseline secondary control for the IBR; and generating the output secondary control as a composite secondary control based on the neural secondary control and the baseline secondary control.

The operations of the system can further include: generating a derivative of system dynamics for the current time step based on the prediction outputs, wherein the neural secondary control is the composite secondary control; and iterating the derivative to generate an output system state to be used as the input for a next time step. The operations can further include iterating receiving, processing, and executing for the next time step.

In the operations of the system, the power parameters received as input can include at least active power, reactive power, voltage, and current.

In accordance with another embodiment, there is disclosed a method of controlling an inverter-based resource (IBR) on a power distribution network, wherein the method includes the following operations.

In particular, the operations of the method include: receiving as input measured input power parameters for a current time step and an input system state related to the IBR as calculated for a previous time step, wherein the input system state is simulated or measured when the current time step is a first time step and there is no previous time step; processing the input power parameters and the input system state using a neural Port-Hamiltonian controller, including trained neural networks with an embedded Lyapunov function which includes physical constraints of the power distribution network, to generate prediction outputs including a Hamiltonian function, several structure matrices, and a neural secondary control; and executing the Lyapunov function based on the Hamiltonian function and the neural secondary control that satisfies the physical constraints, wherein the IBR is capable of being controlled using an output secondary control based at least on the neural secondary control, ensuring passivity and stability of the power distribution network.

The operations of the method can further include transmitting the neural secondary control as the output control secondary control to an IBR controller, the IBR controller being configured to control the 113R based on a primary control generated by the IBR controller and the neural secondary control.

The operations of the method can further include: optimizing the neural secondary control to an optimized neural secondary control; and transmitting the optimized neural secondary control as the output secondary control to an IBR controller, the IBR controller being configured to control the IBR based on a primary control generated by the IBR controller and the optimized neural secondary control. In some cases, the neural secondary control is optimized using Gurobi optimization to form the optimized neural secondary control.

The operations of the method can further include: generating a derivative of system dynamics for the current time step based on the prediction outputs, and integrating the derivative to generate an output system state to be used as the input for a next time step. The operations can further include iterating receiving, processing, and executing for the next time step.

The operations of the method can further include: processing the input power parameters using a baseline controller to generate a baseline secondary control for the IBR; and generating the output secondary control as a composite secondary control based on the neural secondary control and the baseline secondary control.

The operations of the method can further include: generating a derivative of system dynamics for the current time step based on the prediction outputs, wherein the neural secondary control is the composite secondary control; and integrating the derivative to generate an output system state to be used as the input for a next time step. The operations of the method can further include iterating receiving, processing, and executing for the next time step.

In the operations of the method, the power parameters received as input can include at least active power, reactive power, voltage, and current.

These and other purposes, goals, and advantages of the present application will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings in which:

FIG. 1 illustrates an example schematic diagram of a single machine infinite bus (SMIB) system;

FIG. 2 illustrates an example schematic diagram of a power distribution system that includes a number N of IBRs;

FIG. 3 illustrates a schematic of an overall proposed neural GFM^{H} architecture and methodology for open-loop training, as well as closed-testing (control);

FIG. 4 illustrates an example schematic diagram of neural network design that embeds constraints directly into the neural GFM^{H} network architecture to ensure passivity and stability directly, as particularly illustrated in FIG. 3;

FIG. 5 illustrates an example schematic diagram of the power distribution system illustrated in FIG. 2 with a composite controller that integrates a DAPI baseline controller and the proposed neural GFM^{H} controller, used to provide a secondary composite control signal u on top of a primary control signal of the primary local GFM controller (e.g., IBR droop controller) for individual IBRs;

FIG. 6A and FIG. 6B illustrate example time-domain trajectories of a system state represented by state variables in two distinct fault (disturbance) scenarios of the SMIB system;

FIG. 7A and FIG. 7B illustrate example predictions of \dot{p} and \dot{q} for the two fault scenarios illustrated respectively in FIGS. 6A and 6B;

FIG. 7C and FIG. 7D illustrate example learned candidate Lyapunov functions \hat{L}(t) for the respective two fault scenarios as illustrated in FIGS. 6A and 6B;

FIG. 7E and FIG. 7F illustrate respective derivates of the candidate Lyapunov functions \hat{L}(t) for two fault scenarios, as illustrated in FIGS. 7C and 7D;

FIG. 8A and FIG. 8B respectively illustrate example active power and voltage curves of a fault case in an example three-bus system;

FIG. 8C and FIG. 8D illustrate a respective load change for the active power and voltage of the fault case in the three bus-system, as illustrated in FIGS. 8A and 8B;

FIG. 9A and FIG. 9B illustrate an example Lyapunov function of the foregoing three-bus system;

FIGS. 10A-10D illustrate a comparison of performance of the example neural GFM^{H} controller versus a standalone DAPI controller under a fault case as well as under a load change case, in each case for an example IBR in the foregoing 37-bus system;

FIGS. 11A-11D illustrate a comparison of performance of a DAPI controller and a combined DAPI controller with the example neural GFM^{H} controller under a fault case, in each case for an example IBR in the foregoing 37-bus system;

FIG. 12A and FIG. 12B illustrate performance under a fault case without use of any neural controller, in each case for an example IBR in the foregoing 37-bus system;

FIG. 13A and FIG. 13B illustrate voltage and normalized f(p.u.) value for the fault case using the combined DAPI controller with the example neural GFM^{H} controller, in each case for an example IBR in the foregoing 37-bus system;

FIG. 14A and FIG. 14B illustrate output active power P(p.u.) and reactive power Q(p.u.) using a combined DAPI-neural GFM^{H} controller, for an example IBR in the foregoing 37-bus system;

FIG. 15A and FIG. 15B illustrate voltage V using different control methods (controllers) with an uncertainty Δp, for an example IBR in the foregoing 37-bus system;

FIG. 16 illustrates an example composite controller including a classical grid-forming controller and its methodology combined with an example neural GFM^{H} controller and its methodology as described herein, with the composite controller capable of forming a secondary control for an IBR controller to control an associated IBR on a power distribution system, as illustrated in FIG. 5;

FIG. 17 illustrates an example neural GFM^{H} controller distributed locally in an example IBR of an example power distribution system;

FIG. 18 illustrates an example neural GFM^{H} controller deployed in a neural control layer of an example control facility, remotely from an example IBR in an example power distribution system; and

FIG. 19 illustrates a block diagram of an example general computer system capable of performing any methods or computer-based functions in accordance with FIGS. 1-18.

### DETAILED DESCRIPTION

Described herein are a system and method directed to a system and method of grid-forming Hamiltonian control in IBR-rich grids enabling scalability, stability, and passivity. In the following description, for the purposes of explanation, numerous specific details are set forth in order to provide a thorough understanding of example embodiments or aspects. It will be evident, however, to one skilled in the art, that an example embodiment may be practiced without all of the disclosed specific details.

### Port Hamiltonian System

Ensuring passivity in general power grids and microgrids is of critical importance, as it underpins stability and enables seamless integration of inverter-based resources (IBRs). A compositional property of a Port-Hamiltonian system (PHS) guarantees passivity preservation under subsystem interconnection, and the associated Hamiltonian function furnishes a physically interpretable foundation for Lyapunov stability analysis. In control theory, passivity is a property of a system where the total energy supplied to the system is always greater than or equal to the energy it outputs. Hamiltonian function H: [symbol] → [symbol] where [symbol] is a state ace, serves as a candidate storage function for proving passivity. It represents the total stored energy of the system, wherein:

$$H ( x ) \geq 0 , H ( x ) \to 0 as x \to 0. \qquad ( 1 )$$

A system is passive if there exists a non-negative storage function H such that the rate of change of stored energy is less than or equal to the supplied energy. To be exact, over the time span [0, t], with control input u∈ [symbol] ^{m}, system output y∈ [symbol] ^{m}, and state variable x=[x₁, . . . xₙ]^{T} ∈ [symbol] ⁿ, the system is passive if there exists a nonnegative storage function H: [symbol] ₙ→ [symbol] ₊ such that:

$${\int }_{0}^{t} {u}^{⊤} ( τ ) y ( τ ) d τ \geq H ( x ( t ) ) - H ( x ( 0 ) ) \qquad ( 2 )$$

A PHS is an extension of the Hamiltonian framework that incorporates external interactions and energy exchanges through ports, particularly in interconnected systems. The dynamics of a PHS are governed by:

$$\dot{x} = [ J ( x ) - R ( x ) ] \frac{\partial H ( x )}{\partial x} + G ( x ) u \qquad ( 3 a )$$

$$y = {G}^{⊤} ( x ) \frac{\partial H ( x )}{\partial x} \qquad ( 3 b )$$

Here, a smooth storage function H is also called the Hamiltonian function of the system. J(x), R(x)∈ [symbol] ^{n×n} structure matrices. J(x) corresponds to a power-continuous interconnection in the network model and is skew-symmetric, i.e., J(x)=−J(x)^{T}. R(x) is a symmetric matrix depending smoothly on x, i.e., R(x)=R(x)^{T}. These matrices define the geometric structure of the state space of the energy variables. If H(x) is non-negative and R(x) is positive semi-definite, H(x)≥0 and R(x) [symbol] 0, then this system is passive, and H(x) represents the total stored energy.

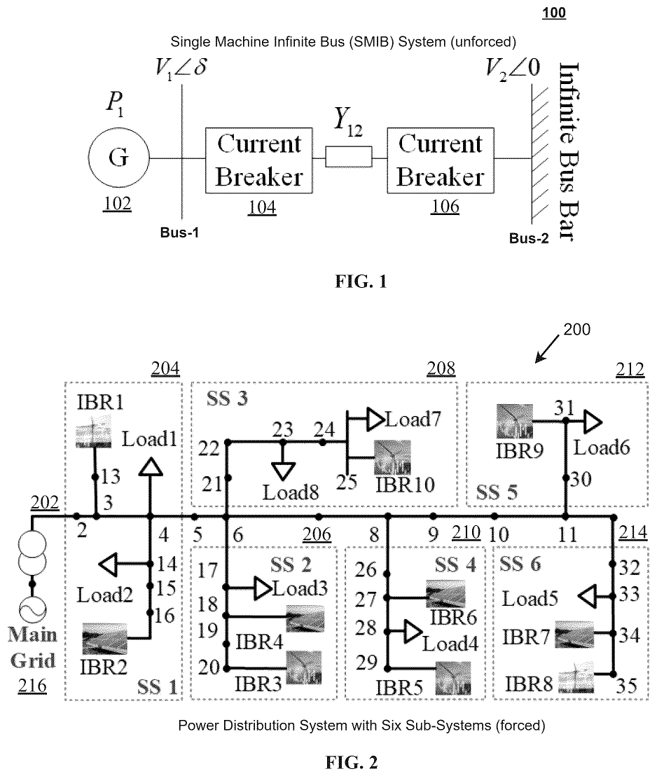

FIG. 1 illustrates an example schematic diagram of a single machine infinite bus (SMIB) system 100. To give a physical example, consider the SMIB system 100 illustrated in FIG. 1, which is unforced with a control input u=0. The system 100 includes a generator G 102 generating active power P₁, buses 1 and 2 (e.g., bus 2 being an infinite bus bar), as well as current breakers 104, 106 and a bus acceptance line Y₁₂ disposed between the busses. Notably, energy loss to the external environment is considered in this special case, making it a nearly-Hamiltonian system. This extends the Hamiltonian framework to dynamic systems with energy dissipation.

Its swing equation can be explicitly derived by:

$${m}_{1} \ddot{δ} + d \dot{δ} + {Y}_{12} {V}_{1} {V}_{2} sin ( δ ) - P 1 = 0 \qquad ( 4 )$$

wherein m₁>0 is a generator inertia constant, d≥0 represents a damping coefficient. Moreover, Y₁₂ is a bus susceptance of a line between buses 1 and 2, V₁ and V₂ are respectively the voltage magnitudes at buses 1 and 2, and δ represents a voltage angle difference between buses 1 and 2.

A position is defined as q=δ, and momentum is defined as p=m₁δ. Let the state variables be a combination of generalized positions and momentum [q, p]^{T}. Then, its state-space model can be expressed as \dot{x}=(J−R)∇H, where j and R are 2×2 matrices defined as:

$$J = [ \begin{matrix}0 & 1 \\ - 1 & 0\end{matrix} ] , R = [ \begin{matrix}0 & 1 \\ 0 & d\end{matrix} ] \qquad ( 5 )$$

It state-space function is therefore:

$$[ \begin{matrix}\dot{q} \\ \dot{p}\end{matrix} ] = [ \begin{matrix}0 & 1 \\ - 1 & - d\end{matrix} ] [ \begin{matrix}\frac{\partial H}{\partial q} \\ \frac{\partial H}{\partial p}\end{matrix} ] \qquad ( 6 )$$

Its Hamiltonian function can be derived as:

$$H = - {P}_{1} q - {Y}_{12} {V}_{1} {V}_{2} cos ( q ) + \frac{{P}^{2}}{2 {m}_{1}} + {Y}_{12} {V}_{1} {V}_{2} \qquad ( 7 )$$

$$wherein$$

$$\frac{\partial H}{\partial q} = {Y}_{12} {V}_{1} {V}_{2} sin ( q ) - {P}_{1}$$

$$\frac{\partial H}{\partial p} = \frac{P}{{m}_{1}} \cdot H ( 0 ) = 0$$

The foregoing example illustrates construction of the Hamiltonian function H and corresponding J and R matrices of the state model of the system. However, this is a simplified special case with no control input u, for which the Hamiltonian function can be derived explicitly in closed form. In the following description, this framework is extended to a more general setting.

### Physical Lyapunov Function

Although PHS offers structure-preserving modeling advantages, its stability remains unknown. The following description bridges the gap between PHS modelling and stability analysis. The PHS illustrated hereinabove in Equation (3) satisfies the following power-balance equation:

$$\frac{dH}{dt} = \frac{\partial {H ( x )}^{⊤}}{\partial x} R ( x ) \frac{\partial H ( x )}{\partial x} + {u}^{⊤} y \qquad ( 8 )$$

wherein u^{T}y is a power externally supplied to the system and a first term on the right-hand side of the equations represents an energy dissipation due to resistive elements in the system.

From the above power-balance Equation (8), a stability of an uncontrolled (or unforced) system can be analyzed from the properties of the Hamiltonian function H in afore-described section entitled Port-Hamiltonian system. However, this does not apply if control variable u≠0. In this case, the system becomes controlled (or forced), with the input ũ leading to a forced equilibrium \tilde{x}. The forced \tilde{x} are solutions of:

$$[ J ( \tilde{x} ) - R ( \tilde{x} ) ] \frac{\partial H ( \tilde{x} )}{\partial \tilde{x}} + G ( \tilde{x} ) \tilde{u} = 0 \qquad ( 9 )$$

Inserting u=ũ in Equation (8) yields:

$$\frac{dH}{dt} = \frac{{\partial }^{⊤} H ( x )}{\partial x} R ( x ) \frac{\partial H ( x )}{\partial x} + {\tilde{u}}^{⊤} {G}^{⊤} ( x ) \frac{\partial H ( x )}{\partial x} \qquad ( 10 )$$

The right-hand side of the equation is not guaranteed to be negative. Thus, the Hamiltonian function H cannot be used directly as a Lyapunov function to analyze stability of a forced equilibrium \tilde{x}. This leads to a challenge of constructing a physically grounded Lyapunov function by leveraging the Hamiltonian function. By moving the second term on the right-hand side to the left-hand side in Equation (10), a candidate Lyapunov function is formulated based on the Hamiltonian function H and the control input u:

$$V ( x ) = H ( x ( t ) ) - {u}^{T} {\int }_{0}^{t} γ ( τ ) d τ \qquad ( 11 )$$

If V is constructed to be continuously differentiable and satisfy V(x)=0 for all x≠0, V(x)=0, and \dot{V}(x)≤0, then the system is stable.

In special cases, such as the unforced SMIB system described with reference to FIG. 1, the candidate Lyapunov function simplifies to L=H(t), thus making stability equivalent to passivity. A derivative of the candidate Lyapunov function is given by:

$$\frac{dL}{dt} = {P}_{1} \dot{q} - 0 {V}_{1} {V}_{2} sin ( q ) \dot{q} + \frac{P}{{m}_{1}} \dot{p} = \frac{{P}^{2}}{{m}_{1}^{2}} d$$

Therefore,

$$\frac{dL}{dt} \leq 0 .$$

By introducing a shifted Hamiltonian \tilde{H} with adjusted initial conditions, L=H remains strictly nonnegative, and L is always nonpositive. Thus, its stability is proven. The shifted Hamiltonian \tilde{H} is described in subsection D of the section entitle physics-informed learning for the Port-Hamiltonian system.

FIG. 2 illustrates an example schematic diagram of a power distribution system 200 that includes a number N of IBRs. In particular, the power distribution system 200, which can be considered a microgrid, includes a bus 202 and subsystems 204-214, each of which includes one or more loads (not individually labeled) and one or more IBRs (not individually labeled) that are connected to the bus 202, which in turn is connected to a main grid 216.

In particular, the power system 200 is a forced system with a nonzero control input, where the Hamiltonian function H cannot be readily derived. The Hamiltonian for the power distribution system 200 can be represented as:

$$H = {H}_{Grid} + {H}_{Load} + {H}_{IBR} \qquad ( 12 )$$

wherein H is an overall Hamiltonian H that includes H_{Grid}, H_{Load}, and H_{IBR}. H_{Grid} represents the Hamiltonian function of the power grid, and it is passive. H_{Load} is the passive PQ load (or PQ bus load), i.e., an electrical load where real power (P) and reactive power (Q) are known in the power distribution system 200. Then, the objective is to design a passive H_{IBR} for each IBR to render the overall Hamiltonian H passive. The challenge lies in achieving passivity for H_{IBR} while meeting control objectives. Leveraging the property of passivity, which guarantees that adding a passive subsystem preserves system passivity, inverters of the IBRs can be analyzed in a distributed manner, e.g., one at a time.

The following equations can be considered as hierarchical control for an IBRᵢ, wherein i∈1, . . . , N.

$${ω}_{i} = {ω}_{i}^{⋆} - {m}_{p , i} , ( {P}_{i} - {P}_{i}^{*} + Δ {P}_{i} ) + {Ω}_{i} \qquad ( 13 )$$

$${E}_{i} = {E}_{i}^{⋆} - {n}_{q , i} ( {Q}_{i} - {Q}_{i}^{*} ) + {e}_{i} .$$

wherein ωᵢ, Eᵢ, Pᵢ, and Qᵢ respectively denote an angular speed, output voltage magnitude, active power, and reactive power of an IBRᵢ, superscript * denotes a nominal values, m_{p,i} and n_{q,i} denote droop coefficients, Ωᵢ and eᵢ respectively denote secondary control signals. Specifically, ΔPᵢ represents an impact of uncertainties from renewables on IBR's power generation, making the networked power grid an uncertain dynamic system. Moreover, u=[Ω₁, . . . , Ω_{N}, e₁, . . . , e_{N},]^{T} denotes the assembling of secondary control signals of all IBRs, while uᵢ=[Ωᵢ, eᵢ] denotes a secondary control signal for i^{th} IBR, i.e., IBRᵢ.

The system under neural hierarchical control can be formulated as follows:

$$\dot{x} = ( J ( x ) - R ( x ) ) {∇}_{x} {H}_{IBR} + G ( x , θ ) u \qquad ( 14 )$$

wherein θ is an uncertain parameter of a power grid, x=[δ; P; Q; φ; γ; i_{L}; vₒ; iₒ], δ is the IBR angle, P is active power generation, Q is reactive power generation, φ is an output signal of a voltage controller in the dq-axis, γ is an output signal of a current controller in dq-axis, i_{L} is a dq-axis current after an output LC filter, and vₒ and iₒ are respectively a dq-axis voltage and dq-axis current of IBR.

Since the Hamiltonian function lacks an analytical solution, neural networks are employed to learn a solution, as described in the following section.

### Physics-Informed Learning for the Port-Hamiltonian System

### A. Learning-Based PHS Modelling

A dynamic networked power grid (e.g., networked microgrid “NM”) with hierarchical control can be formulated as a set of ordinary differential equations (“ODE”):

$$\dot{x} = f ( x , θ ) + g ( x , θ ) u ( x ) \qquad ( 15 )$$

wherein u is a control, f and g are functions describing power grid dynamics and are assumed to be locally Lipschitz, θ is an uncertain parameter of the power grid, and \dot{x} is a derivative of the power grid dynamics (system dynamics). An ODE-based formulation or model is rigorously equivalent to an original differential algebraic equation (DAE)-based model (e.g., DAE-based model is a framework that simulate dynamic behavior of a grid by combining differential equations describing system dynamics with algebraic equations describing network constraints). However, the ODE-based model is numerically more stable than its DAE-based model counterpart. It is intuitive to recast Equation (15) into the format of Equations (3a, 3b), with a prerequisite that this reformulation adheres to constraints required to maintain passivity:

$$x = ⌈ {J}_{𝒩} ( x ) - {R}_{𝒩} ( x ) ] \frac{\partial {H}_{𝒩} ( x )}{\partial x} + G ( x , θ ) {u}_{𝒩 ( x )} \qquad ( 16 a )$$

$$y = {G}^{T} ( x , θ ) \frac{\partial {H}_{𝒩} ( x )}{\partial x} \qquad ( 16 b )$$

wherein only G, the control input matrix, is known as prior. However, [symbol] , [symbol] , and [symbol] are learned from neural networks. The corresponding Lyapunov function is calculated once the Hamiltonian is learned:

$$V ( x ) = {H}_{𝒩} ( x ( t ) ) - {u}_{𝒩}^{T} {\int }_{0}^{t} y ( τ ) d τ \qquad ( 17 )$$

### B. Methodology Architecture

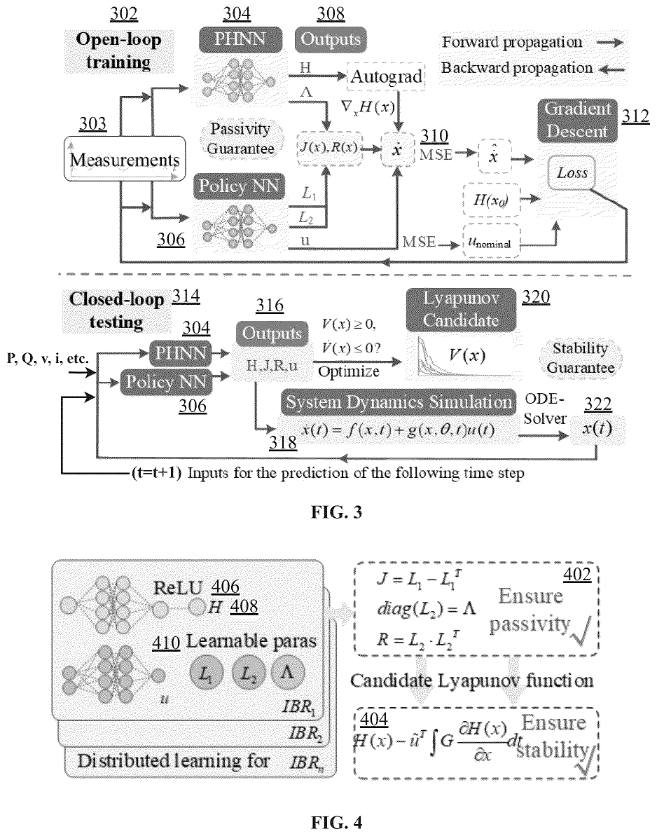

FIG. 3 illustrates a schematic of an overall proposed neural GFM^{H} architecture and methodology for open-loop training 302, as well as closed-testing (control) 314. There are two primary objectives of the proposed methodology: neural PH model discovery and a physical Lyapunov-based neural control to ensure system passivity and stability. These objectives are addressed using two lightweight neural networks, Port-Hamiltonian neural network (PHNN) 304 and Lyapunov-based policy neural network (Policy NN) 306, each respectively dedicated to its task.

In the following, the Hamiltonian H refers to the H_{IBR} as defined in Equation (12) for clarity and brevity. The variables H, Λ, L₁, L₂, u 304 and variables J, R, H, and u 316 are outputs from the neural networks 304, 306, while G(x) is parametrized directly via x and is therefore known a priori, as explained hereinbelow. As particularly outlined in the section entitled Port-Hamiltonian system in view of FIG. 1, in order to ensure passivity, the following constraints are imposed: (1) J is skew-symmetric and (2) R is symmetric positive semidefinite, i.e., R(x)^{T}=R(x), R(x) [symbol] 0, and (3) H is nonnegative.

In the Port-Hamiltonian formulation

$$\dot{x} = ( J ( x ) - R ( x ) ) {∇}_{x} H ( x ) + G ( x , θ ) u ( x ) ,$$

the term G(x) or more precisely G(0, 0) denotes a control-input (port) mapping. It is a state dependent matrix that maps the secondary control vector u(x) (e.g., frequency and voltage control signals) into the state dynamics. Physically, the columns of G(x, θ) encode how each control port injects or extracts power through the converter and network, thereby influencing evolution of angles, voltages, and currents. In the GFM^{H} framework, G(x, θ) is determined from underlying electrical and converter equations and not learned, wherein the learning is particularly applied to H(x), J(x), and R(x).

In open-loop training 302, measurements 303 of the system (e.g., current system state x and baseline control information) are received as input and processed via the neural networks 304, 306 to generate outputs 308. In particular, PHNN 304 outputs variables H and Λ, while the Policy NN 306 outputs variables L₁, L₂, and u. Variable A output from PHNN 304 is combined with variables L₁, L₂ output from Policy NN 306, forming variables J(x), R(x). Output variable H is processed via Autograd (e.g., automatic differentiation) to form variables ∇ₓH(x). Thereafter, variables ∇ₓH(x), J(x), R(x), and u are combined to compute a predicated derivative of system dynamics \dot{x} 310. The predicated \dot{x} (e.g., denoted as \dot{x}_{pred}) is used to compute a loss function against a system dynamics \hat{\dot{x}}, which denoted a ground truth (e.g., target) that can be a result of simulation or a measurement. A mean squared error (MSE) is used to determine a dynamics error between the ground truth system dynamics \hat{\dot{x}} and the predicated system dynamics \dot{x} as computed. Similarly, MSE is used to determine a control error between uₙₒₘᵢₙₐₗ (e.g., “ground truth” of control) and a neural secondary control u as computed. A loss function is then calculated based on the dynamics error, control error, and initial energy condition H(x₀) to generate a gradient of the loss 312 (e.g., combining dynamics error, control error, and initial energy condition). The gradient is compared to an acceptable gradient loss threshold. If the computed loss gradient is greater than the threshold, the open-loop training 302 is iterated from operation 303 until the gradient of the loss 312 is lower than or equal to the gradient loss threshold (e.g., gradient is minimized). Once the loss gradient is minimized, the neural networks PHNN 304 and Policy NN 306 have been trained in relationship to the system, such as power distribution system 200 as particularly illustrated in FIG. 2.

As an example, during training a dataset of system trajectories is obtained from simulation and/or measurement. For each sample, the current system state x and, where applicable, a baseline secondary control uₙₒₘᵢₙₐₗ (e.g., nominal secondary control) is supplied as input. A ground-truth system dynamics derivative \hat{\dot{x}} from a simulation or measurement acts as a target. The neural networks 304, 306 produce a learned Hamiltonian H(x), structure matrices J(x) and R(x), and a neural secondary control u(x). From these variables, a predicted system dynamics derivative z is computed as follows:

$${\dot{x}}_{pred} = J ( x ) - R ( x ) ) ∇ xH ( x ) + G ( x , θ ) u ( x ) .$$

The loss computation of the gradient loss during training penalizes (i) a mismatch between \dot{x}_{pred} and ground truth \hat{\dot{x}}, (ii) a deviation of the energy from a prescribed initial condition H(x₀)=0, and (iii) a deviation of a neural secondary control u(x) from a nominal baseline control uₙₒₘᵢₙₐₗ.

In closed-loop testing (control) 314, the trained neural networks 304 and 306 of the neural GFM^{H} controller for an example power system 200 receive a system state x for a first or current time step (t), thus receiving system state x(t), and in addition, receive current measured variables such as P, Q, v, i, etc. of the power system 200. In a first time step where t=0, initial state x(t) 322 can be obtained from simulation or measurement of the power system 200, wherein for successive time steps x(t) 322 is computed during each preceding time step of closed-loop testing (control). Closed-loop testing (control) of the neural GFM^{H} controller follows an algorithmic loop, where in each time step the following is performed: (i) determine H, J, R, and u via the trained neural networks, (ii) compute Lyapunov function V(x) to satisfy constraints, (iii) refine control u via Lyapunov constrained optimization, (iv) determine system dynamics \dot{x}=f(x)+g(x)u(x) by substituting the refined u, and (v) integrate \dot{x} via an ODE solver to obtain a state x for a next time (t), i.e., t=t+1.

Accordingly, the trained neural networks 304, 306, process the system state x(t) and received values of measured variables to generate outputs 316, including intermediate variables H, J, R, and u. The outputs 316 are used to compute a candidate Lyapunov function 320 embedded in the Policy NN 306 so as to satisfy stability constraints.

For reference purposes, a candidate Lyapunov function V(x) is constructed from a learned Hamiltonian and port variables, for example, in the following form:

$$V ( x ) = H ( x ( t ) ) - {u}^{T} {{\int }_{0}^{t}}^{ } {G}^{T} ( x ( τ ) ) ∇ xH ( x ( τ ) ) d τ .$$

This candidate captures stored energy minus accumulated supplied power at the control ports. During closed-loop testing (control), V(x) and its time derivative \dot{V}(x) are evaluated online and used as constraints (e.g., V(x)=0 and \dot{V}(x)≤0) in a small optimization problem that adjusts the neural secondary control u(x). In an embodiment, the neural GFM^{H} controller solves the following equation:

$${min}_{u , r} = {‖ u - {u}_{nomimal} ‖}_{2}^{2} + l {r}^{2}$$

subject to \dot{V}(x)≤r and r≥0, where uₙₒₘᵢₙₐₗ is a nominal control, [symbol] is a penalty parameter, and r is a slack variable. The solution of this equation yields a refined output secondary control u that remains close to the nominal control uₙₒₘᵢₙₐₗ, while enforcing non-increasing V(x) (e.g., up to the slack), thereby providing a Lyapunov-guided stability guarantee. The output neural secondary control of the Lyapunov function is thus optimized (e.g., using Gurobi optimization) to generate the refined control u.

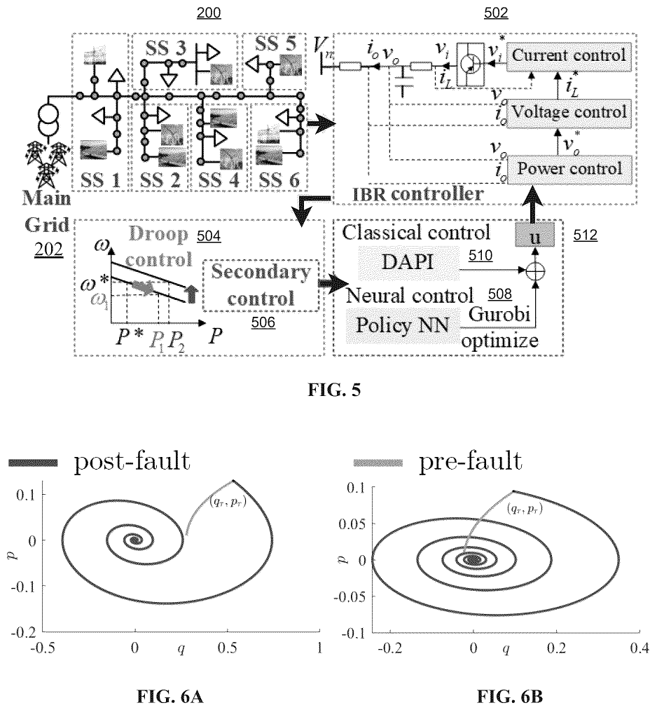

A derivative of system dynamics \dot{x}(t) 318 is determined by substituting the refined control u for u(t), thus generating \dot{x}(t)=f(x, t)+g(x, θ, t)u(t), wherein functions f and g describe power grid dynamics of the power system 200 and u(t) is a secondary control for the power system 200, as illustrated in the example power system 100 of FIG. 2. It should be noted that the secondary control u(t) is the output control u of the neural GFM^{H} controller that can be transmitted to an IBR controller (FIG. 5), either by itself or in combination with a DAPI secondary control thus forming a composite value u, wherein in such as system dynamics \dot{x}=f(x)+g(x)[u_{DAPI},(x)+u(x)], to be used by an IBR controller in combination with its local control policy to control the IBR in the example power system 200, as particularly illustrated in FIGS. 2 and 5. Lastly, the derivative of system dynamics \dot{x}(t) is solved (integrated) via an ODE solver 322 to generate a system state x(t) of the power system 200 for the next time step (t=t+1). The system state x(t) is then used as input to neural networks 304, 306, in combination with newly received values of parameters P, Q, v, i, etc. of the power system for the next time step (t=t+1), so as to generate a new output control value u for the next time step.

As an example, during testing a current system state x(t) is constructed at a given time step (e.g., during a control interval) from a previous/initial system state and power measurements of that time step, e.g., P, Q, v, i, as well as internal controller states, if any. This current system state x(t) is then provided as input for a next time step to neural GFM^{H} controller, which outputs H(t), J(t), R(t), and a neural secondary control u. A Lyapunov-based optimization may refine secondary control u subject to the stability constraints, and the resulting control u is applied through Port-Hamiltonian dynamics z(t)=f(x, t)+g(x, θ, t)u(t), or for combined DAPI-neural GFM^{H} controller \dot{x}=f(x)+g(x)[u_{DAP},(x)+u(x)], where U_{DAPI}(x) denotes a baseline grid-forming controller, e.g., a DAPI controller The differential equation is integrated by a numerical solver (e.g., ODE solver) to obtain a next state denoted x(t+1), or stated another away x(t+Δt), where Δt is time span when added to a time of the previous step represents a next control interval.

There are challenges of satisfying constraints. How can the outputs from neural networks satisfy constraints during training?One common approach in purely data-driven training is to penalize the neural network severely if its outputs a fail indication to satisfy the constraints. However, this approach can be hazardous in this context, as these constraints have physical meanings, making them nontrivial to enforce directly. Verifying constraint compliance element-wise during each a plurality of training epochs becomes computationally challenging, significantly increasing complexity. On the other hand, J and R are intermediate variables, while the primal focus is on main output variables H and u. Directly imposing penalties on violations of the constraints can cause divergence during training if the penalties are not carefully designed, potentially hindering training for the main outputs.

FIG. 4 illustrates an example schematic diagram of neural network design that embeds constraints 402, 404 directly into the network architecture 302, 314, to ensure passivity and stability directly, as illustrated in FIG. 3.

The following describes design principles for qualified J and R matrices. In particular, three sets of learnable parameters 410 are defined—L1, L2, and A. Parameters L1 and L2 are reshaped as lower triangular matrices predicted from the neural network Policy NN 306, and parameter A is a vector of non-negative values predicted from the Port-Hamiltonian neural network PHNN 304. Diagonal elements of L2 are replaced with A so that L2 has non-negative diagonal entries. Then J and R matrices can be derived by:

$$J = {L}_{1} - {L}_{1}^{T} \qquad ( 18 )$$

$$diag ( {L}_{2} ) ← Λ . s . t . Λ \geq 0$$

$$R = {L}_{2} - {L}_{2}^{T}$$

Accordingly, parameters L1, L2, and A are learned and reshaped so that

$$J = {L}_{1} - {L}_{1}^{T}$$

is skew-symmetric, and

$$R = {L}_{2}^{T} {L}_{2} + diag ( Λ )$$

is symmetric positive semidefinite.

The foregoing describes design principles for the Hamiltonian Function H 408. It should be noted that a rectified linear unit (ReLU) activation function 406 is disposed in a last layer of the PHNN 304, as particularly illustrated in FIG. 4. The rectified linear unit (ReLU) is non-linear activation function that directly outputs positive input values and sets all negative inputs to zero. In particular, as ReLU(x)=max(0,x), outputs H and A are guaranteed to be non-negative, as well as non-negative diagonal entries of R. Accordingly, the architecture in FIG. 4 and Equation (18) satisfy a prerequisite of a skew-symmetric J, a symmetric positive semidefinite R, and a nonnegative H. The sizes of L1, L2, and A are determined by dimensions of the system studied and/or tested. Since GFM^{H} supports distributed learning, a dimensionality of each subsystem is typically manageable, if the power system is properly partitioned. Accordingly, the foregoing by design enforces Port-Hamiltonian structural conditions, i.e., skew-symmetric J, symmetric positive semidefinite R, non-negative H, thus underpinning passivity and stability.

C. Embedding Physical Knowledge into Loss Functions

Inspired by data-efficient physics-informed learning, physical constraints were incorporated directly into the training process to accelerate convergence. By doing so, it is ensured that, for every starting point in training sets, passivity and stability of each subsystem are preserved throughout a learning process. With the constraints satisfied as described in the subsection B of the section entitled physics-informed learning for Port-Hamiltonian system, a next step is to design a loss function to train desired outputs H and u.

$$\dot{x} = ( J - R ) ∇ H + Gu {ℒ}_{1} = {‖ \dot{x} - \hat{\dot{x}} ‖}_{2} {ℒ}_{2} = {H ( {x}_{0} )}^{2} {ℒ}_{3} = {‖ u ( x ) - {u}_{n o m o n inal} ‖}_{2} \qquad ( 19 )$$

PH physics is embedded in [symbol] ₁ as \dot{x} is calculated via Equation (14). The term \hat{\dot{x}} denotes a ground truth value. If H(0)=0, H(x)≥0 for all x⊆ [symbol] ⁿ, then H serves as a storage function of a passive system. As illustrated in FIG. 4, the neural network architecture design showcases that a predicted H is nonnegative by adding a ReLU layer at the end. To enforce the initial condition H(x₀)=0, the term [symbol] is introduced.

It should be recalled that one of the objects is to determine a control input u that renders the PH system passive. To expedite training, a nominal controller uₙₒₘₒₙᵢₙₐₗ (e.g., a linear quadratic regulator (LQR) policy) is introduced to guide a search process and avoid random exploration of a control space, as defined in [symbol] ₃.

During closed-loop testing, where the neural controller is integrated into the system for real-time operation at each time step, the controller u is further optimized to ensure that it satisfies the criteria for a valid PH system while maintaining system stability. Further details on the optimization process are provided in subsection B2) of the section entitled case study.

Although two independent neural networks are deployed as illustrated in FIG. 3, the neural networks share the same objective of accurately representing a state-space function with respect to x by identifying suitable H and u. Consequently, the PHNN 304 and Policy NN 306 share the same loss function [symbol] :

$$ℒ = {ℒ}_{1} + {ℒ}_{2} + {ℒ}_{3} \qquad ( 20 )$$

### D. Harmonizing Baseline GFM Control and Neural Control

One limitation of the physics-based neural controller is its lack of emphasis on returning to an original reference value. As an example, a physics-informed neural hierarchical control is intended for safe and stable operation, yet as a load changes in the system, it is possible that the system settles at a different steady state rather than restoring the original reference value. Accordingly, a primary objective is to maintain stability and passivity by optimizing control input u to satisfy passivity constraints. Unlike proportional integral (PI) controllers, achieving the reference value is not inherently its objective. To overcome this, proposed herein is a composite control strategy that ensures both stability and convergence to the reference value.

Without loss of generality, it is assumed that the IBRs adopt distributed adaptive proportional-integral (“DAPI”) as their baseline secondary control on top of primary local GFM control (e.g., droop control) at individual IBRs. In this regard, it should be noted that inventive GFM^{H} controller can thus coordinate with any primary local GFM controller in similar fashion. In particular, a DAPI controller is an average consensus-based integral controller which provides a popular secondary control to coordinate multiple IBRs or subsystems (SSs), eliminating frequency and voltage deviations caused by the primary GFM control (e.g., droop control). The DAPI mathematical formulation for the i^{th} IBR in a certain subsystem, where X is a node-set, and i∈χ is:

$$\frac{d {Ω}_{i}}{dt} = - {α}_{i} ( {ω}_{i} = {ω}^{*} ) + {\sum }_{l ∈ {Υ}_{i}} {A}_{li} ( {Ω}_{i} - {Ω}_{l} ) \frac{{de}_{i}}{dt} = - {β}_{i} ( {E}_{i} = {E}_{i}^{*} ) + {\sum }_{l ∈ {Υ}_{i}} {B}_{l i} ( {Q}_{i} / {Q}_{i}^{*} - {Q}_{l} / {Q}_{l}^{*} ) \qquad ( 21 )$$

where Ωᵢ and eᵢ are respectively secondary frequency and voltage control variables as mentioned earlier, except this time they are not derived from the neural networks 304, 306 illustrated in FIG. 3, but via the classical integration as in Equation (21). Y∈χ is a neighboring IBR set of the i^{th} IBR, determined by a local communication network in this subsystem, which corresponds to the nonzero elements on an i^{th} row or column in an adjacent matrix. The control parameters related to frequency and voltage restoration are denoted by α and β, while A and B are related to sharing of active power and reactive power.

To leverage the advantages of both methodologies, proposed herein is an integration of a DAPI controller and a Neural-Hamiltonian controller. First, a DAPI controller is deployed in an original system, yielding a new system with shifted equilibrium points. The resulting new equilibrium, denoted as Q_{eq}, is computed as detailed hereinbelow in subsection F of this section.

After equilibrium recalculation, training on a modified system follows the same procedure as described in subsection C of the section entitled physics-informed learning for a Port-Hamiltonian system. As before, the nominal controller (uₙₒₘᵢₙₐₗ) provides reference signals to accelerate convergence during open-loop training 302. During closed-loop testing 314 as illustrated in FIG. 3, the neural controller is deployed on the modified system, thereby preserving passivity and ensuring closed-loop stability.

The integration of the DAPI controller and neural controller is formulated as:

$$\dot{x} = f ( x ) + g ( x ) {u}_{DAPI} ( x ) + g ( x ) u ( x ) \qquad ( 21 )$$

An improved Euler method can be deployed to enhance accuracy during step-by-step integration of x, as detailed in subsection F of this section. Finally, simulated dynamics x and Hamiltonian function H of the new system are obtained, and then the candidate Lyapunov function is obtained:

$$V ( x ) = H ( x ( t ) ) - {u}^{T} {\int }_{0}^{t} {G}^{T} \frac{\partial H}{\partial x} d τ \qquad ( 22 )$$

During the closed-loop testing 314 illustrated in FIG. 3, a lightweight module is added to further refine the control input u:

$${min}_{u , r} = {‖ u - {u}_{nominal} ‖}_{2} + l * {r}^{2} s . t . dV / dt \leq r , r \geq 0 \qquad ( 23 )$$

wherein l is a relaxation penalty, and r is a non-negative slack variable. Pseudo-code for the proposed method is given immediately below in an algorithm for GFM^{H} Open-loop training and closed-loop testing (control).

GFM^{H} Algorithm for Open-Loop Training and Closed-Loop

Open-Loop Training:
Require: Power grid parameters, G , training data, uₙₒₘᵢₙₐₗ
Ensure: Neural network models
Training samples generation for \hat{x}, \dot{\hat{x}}:
\dot{\hat{x}} = f(x) + g(x)u_{DAPI}(x) + g(x)uₙₒₘᵢₙₐₗ(x)

| | |
|---|---|
| for epoch e = 1 to N do | ( [symbol] training phase) |

```
    Perform forward propagation of neural networks PHNN and Policy
    NN to compute predictions \dot{x} and loss [symbol]   ,
    Perform backward propagation to compute gradients descent,
    Update the NN parameters
end for
Closed-Loop Testing:
Require: Test data, trained models, l, r
```

| | |
|---|---|
| for each test scenario s in S do | ( [symbol] testing phase) |

```
  for each timestep t do
      Apply trained neural models on test data to obtain predictions H,
      J, R, u,
      Compute the physical-based Lyapunov function V and refine u
        using Gurobi optimization,
      Insert u into the system dynamics: \dot{x} = f(x) + g(x)[u_{DAPI}(x) + u(x)],
      Use ODE-solver to obtain x(t)
  end for
end for
Outputs: H, V, u and system state x.
```

### E. Shifted Initial Conditions for an Unforced System

For example, the shifted initial conditions can be for the unforced SMIB system 100 as illustrated in FIG. 1. To set initial conditions with

$${p}_{0} = 0 , {\dot{q}}_{0} = \frac{p}{m} = 0 ,$$

and \dot{p}₀=0, the initial value of q₀ is given by

$${q}_{0} = arcsin ( \frac{{P}_{1}}{{Y}_{12}} ) .$$

To ensure that the system starts at (0, 0), with its Hamiltonian function equal to 0 at the same time, a shift in H is required.

First, there is computed a current initial value at (0, q₀):

$$H ( 0 , {q}_{0} ) = - {P}_{1} {q}_{0} - {Y}_{12} {V}_{1} {V}_{2} cos ( {q}_{0} )$$

Then, H(0, q₀) is subtracted from the original function, and a shifted function \tilde{H}, where \tilde{H}(p, q)=H(p, q+q₀), is given by:

$$\tilde{H} ( p , q ) = - {P}_{1} q - {Y}_{12} {V}_{1} {V}_{2} cos ( q ) + \frac{{P}_{2}}{2 {m}_{1}} + C$$

wherein C=P₁q₀−Y₁₂V₁V₂ cos(q₀) so that \tilde{H}(0,0)=−P₁q₀−Y₁₂V₁V₂ cos(q₀)+0+C=0

### F. Integration of DAPI and Neural Controls

When deploying the DAPI controller 504 on the original system 200 as illustrated in subsection D of the section entitled physics-informed learning for Port-Hamiltonian system, a new equilibrium u_{eq} is recalculated by solving:

$$\dot{x} = f ( {x}_{goal} ) + g ( {x}_{goal} ) {u}_{DAPI} ( {x}_{g o a l} ) + g ( {x}_{goal} ) {u}_{e q} = 0$$

wherein x_{goal} is a desired reference value when the system reaches its steady state. The integration of DAPI and a neural controller is formulated as:

$$\dot{x} = f ( x ) + g ( x ) [ {u}_{DAPI} ( x ) + u ( x ) ]$$

An improved Euler Method can be deployed to enhance accuracy during step-by-step integration as follows:

$${\dot{x}}_{i} = f ( {x}_{i} ) + g ( {x}_{i} ) {u}_{DAPI} ( {x}_{i} ) + g ( {x}_{i} ) {u}_{N N} ( {x}_{i} )$$

$${x}_{i}^{*} = {x}_{i} + Δ t \cdot {\dot{x}}_{i}$$

$${\dot{x}}_{i}^{*} = f ( {x}_{i}^{*} ) + g ( {x}_{i}^{*} ) {u}_{DAPI} ( {x}_{i}^{*} ) + g ( {x}_{i}^{*} ) {u}_{N N} ( {x}_{i}^{*} )$$

$${x}_{i + 1} = {x}_{i} + \frac{Δ t}{2} \cdot ( {\dot{x}}_{i} + {\dot{x}}_{i}^{*} )$$

Then, xᵢ₊₁ is used for integration at a following time step, continuing iteratively until all steps are completed.

FIG. 5 illustrates an example schematic diagram of the power distribution system 200 illustrated in FIG. 2 with a composite controller 504 (e.g., closed-loop workflow) that integrates a DAPI baseline controller 506 and the proposed neural GFM^{H} controller 508 as described herein, used to provide a secondary composite control signal u on top of a primary control signal of the primary local GFM controller (e.g., IBR droop controller) 502 for individual IBRs.

In particular, the neural GFM^{H} controller 508 operates in conjunction with a baseline grid-forming control, such as the DAPI baseline controller 506. The baseline controller 506 designated u_{DAPI} (x) provides conventional secondary control, while the neural GFM^{H} controller 508 outputs an auxiliary secondary control u(x) derived from a learned Hamiltonian structure and Lyapunov constraints, as described herein. These two control contributions are combined to form a composite or fused control (control signal), e.g., for example uₜₒₜₐₗ(x)=u_{DAPI}(X)+u(x), which is then supplied to a converter or an IBR's local GFM controller 502 for controlling the associated IBR. Accordingly, a total control (system dynamics) effectively looks like \dot{x}=f(x)+g(x)u_{DAPI}(x)+g(x)u(x). The foregoing composite scheme augments a proven classical baseline DAPI controller 506 with a correction of the neural GFM^{H} controller 508, improving stability and performance while respecting the underlying energy structure.

Once the Post-Hamiltonian neural network PHNN has learned a converged H function, the neural network Policy NN further refines the neural control u(x) around a nominal control uₙₒₘᵢₙₐₗ, while enforcing Lyapunov constraints as set forth in Equation (23). The composite or fused control uₜₒₜₐₗ(x) is transmitted to the IBR controller 502 for controlling an associated IBR. As already described herein, in alternate embodiments, a control u(x) emanating from the neural GFM^{H} controller 508 can be individually used without control u_{DAPI}(x) of the DAPI baseline controller 506, as an independent secondary control that is transmitted to the IBR controller 502 for controlling the associated IBR.

### Case Study

This case study section validates the proposed methodology through three case studies: (a) a SMIB system unforced with no control applied, (b)(1) a small-scale 3-bus system, and (b)(2) a 37-bus system.

### A. Exemplification in an Unforced SMIB System

In accordance with (a), the following validates accuracy of the predicted H using the unforced SMIB dynamic system 100 as illustrated in FIG. 1, where analytical solutions for H are available. The learned results are compared with the ground truth R to assess their efficacy.

At the beginning, the power system 100 is in a steady state condition with state variables (%, p). Then, a sudden fault occurs at t=0 on a transmission line, causing a fault that causes the circuit breakers 104, 106 to open. In this stage, the system model in Equation (4) now becomes:

$${m}_{1} \ddot{δ} + d \dot{δ} - P 1 = 0 \qquad ( 24 )$$

$$[ \begin{matrix}\dot{q} \\ \dot{p}\end{matrix} ] = [ \begin{matrix}0 & 1 \\ - 1 & - d\end{matrix} ] [ \begin{matrix}\frac{\partial H}{\partial q} \\ \frac{\partial H}{\partial p}\end{matrix} ] \qquad ( 25 )$$

$$where$$

$$\frac{\partial H}{\partial q} = - {P}_{1} , \frac{\partial H}{\partial p} = \frac{P}{{m}_{1}}$$

At time t=τ when the state variables are changed to (q_{τ}, p_{τ}), the circuit breakers 104, 106 are then re-closed. A damping coefficient d under test is selected from the following set of damping coefficient values 0.02, 0.05, 0.08, 0.10. For each damping coefficient, five transient trajectories are generated by performing dynamic simulations with different initial values of qₒ and τ. The trajectories have uniform distributions on an interval [0, 1] and interval [0.1 s, 2.0 s], respectively. In the SMIB system 100, two parameters from uniform distributions are sampled. A first parameter (e.g., an initial rotor-angle or an angle difference state q₀) is drawn from a uniform interval [0, 1], which is dimensionless. A second parameter (e.g., fault clearing time T), is drawn from a uniform interval [0.1 s, 2.0 s], which is expressed in seconds. These sampled parameter values define a family of disturbance scenarios whose resulting trajectories are used to train and test the neural GFM^{H} controller. It should be noted that the SMIB system 100 is transient stable under these settings. The simulation uses a time step interval of 0.1 s.

FIG. 6A and FIG. 6B illustrate example time-domain trajectories of a system state represented by state variables (q, q) in two distinct fault (disturbance) scenarios of the SMIB system 100. Example variable q denotes an angle, while example variable p denotes a conjugate momentum.

In FIG. 6A, a first fault scenario involves q₀=0.8, τ=1.5, and d=0.08, while in FIG. 6B, a second fault scenario involves q₀=0.5, τ=1.0, and d=0.02. For both cases, the blue curve is pre-fault and the purple curve represents post-fault trajectories of states denoted by variables (q, p). The analysis was carried out during a post-fault stage.

The graphs in FIGS. 6A and 6B depict how the state denoted by the variables (q, p) evolves before, during, and after the fault or disturbance. In particular, the trajectories form part of a dynamic dataset used to train and validate H, J, and R in the neural networks of the neural GFM^{H} controller. By demonstrating that the trained neural GFM^{H} controller reproduces the observed state trajectories associated with these scenarios, FIGS. 6A and 6B support a conclusion that the learned Hamiltonian and structure matrices of the neural GFM^{H} controller accurately capture the system's post-fault behavior across a range of operating conditions.

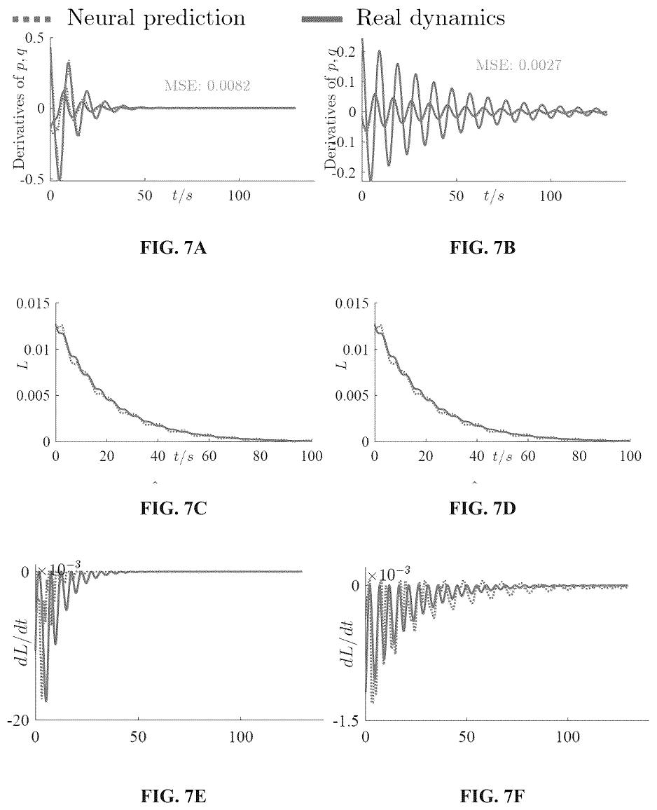

FIG. 7A and FIG. 7B illustrate example predictions of \dot{p} and \dot{q} for the two fault scenarios illustrated respectively in FIG. 6A and FIG. 6B. FIG. 7A, uses predictions of \dot{p} and \dot{q} under the first fault scenario in FIG. 6A, while FIG. 7B uses predictions of \dot{p} and \dot{q} are under the second fault scenario illustrated in FIG. 6A. For the SMIB system 100, J and R are effectively identified, rendering the learning process a straightforward data-driven task.

As particularly illustrated in FIGS. 7A and 7B, ground-truth state derivatives (e.g., \dot{p} and \dot{q}) generated by a simulator are compared over time (in seconds) to corresponding derivatives predicted by a trained neural GFM^{H} controller, for the SMIB fault scenarios as partially illustrated in FIGS. 6A and 6B. The graphs thus overlay the true and predicted derivative trajectories over a time window. As illustrated, the reported mean squared error (MSE) value represents a time-averaged squared difference between the predicted and true derivatives, computed across all sampled time points in the trajectory (e.g., an average of (\dot{x}_{pred}−\dot{x}ₜᵣᵤₑ)² across all sampled time points). As such, a small computed MSE indicates that the trained neural GFM^{H} controller closely matches true dynamics of the SMIB system 100 overtime and not just at isolated time points.

FIG. 7C and FIG. 7D illustrate example learned candidate Lyapunov functions \hat{L}(t) for the respective two fault scenarios, as illustrated in FIG. 6A and FIG. 6B. In particular, each of these figures compares the learned candidate Lyapunov function with an analytical (ground truth) solution, showing a strong agreement between them. In this case, a candidate Lyapunov function equals to a learned H(x), as described hereinabove in the section entitled physical Lyapunov function.

In a SMIB benchmark, an analytical Hamiltonian Hₜᵣᵤₑ is available from first-principles modeling. The learned Hamiltonian H(x) (or derived Lyapunov candidate) is therefore compared directly to ground-truth energy function Hamiltonian Hₜᵣᵤₑ along the simulated trajectories. A strong correlation between the learned candidate and the true Hamiltonian confirms that the network has accurately captured the underlying energy landscape and its evolution. This validation is important because, in larger and more complex multi-IBR systems where an analytical Hamiltonian is not readily obtainable, the learned Hamiltonian H(x) will be used as a surrogate energy function and Lyapunov candidate. Demonstrating high correlation in the benchmark therefore justifies using the learned candidate as an accurate substitute for the unknown ground-truth Hamiltonian in such complex applications.

FIG. 7E and FIG. 7F illustrate respective derivates of the candidate Lyapunov functions \hat{L}(t) for the two fault scenarios, as illustrated in FIG. 7C and FIG. 7D. These results thus confirm that the predicted state derivatives match accurately with the ground truth. In particular, FIG. 7E and FIG. 7F demonstrate that dL/dt≤0 and L≥0, thereby verifying stability of the system 100 as illustrated in FIG. 1. These stability results are further validated by state trajectories that converge to a steady state at (0, 0), as particularly illustrated in FIGS. 6A and 6B.

Comparing the derivatives predicted by the neural GFM^{H} controller to the ground-truth derivatives offers the following two advantages. First, it directly tests whether learned system dynamics \dot{x}=f(x)+g(x)u(x) matches the physical dynamics, rather than only verifying that the trajectories remain close in state space. This is a stricter and more informative condition for validating the learned structure matrices J(x), R(x), Hamiltonian H(x), and port mapping G(x, θ). Matching (p, q) is a stronger validation of the learned J, R, H, G, than matching (p, q) alone. Second, examining the derivative of the Lyapunov candidate \dot{V}(x) along true trajectories, checks whether the candidate exhibits the desired non-increasing behavior, which is central to stability and passivity guarantees. Accordingly, derivative-based comparisons more directly confirm that the learned model and controller enforce the intended dynamics and Lyapunov properties.

### B. Efficacy of Forced Systems

In accordance with (b)(1), a Hamiltonian GFM^{H} neural control is tested on a well-known 3-bus, 3-IBR microgrid system (not shown). There are initial conditions, network, and load parameters. In a non-limiting multi-IBR example, the system is a 3-bus low-voltage microgrid in which three grid-forming inverters are interconnected via resistive-inductive (RL) lines and supply local loads. An electromagnetic transient simulation is performed using a small time step, such as dt is 0.0001 s, so as to capture fast converter dynamics. Key inverter parameters for inverters of IBRs are listed immediately below in Table I, including include converter and controller parameters, voltage- and current-loop gains, integral gains, and droop coefficients, are specified as follows (e.g., Kₚᵥ=0.05, K_{pc}=10.5, K_{ic}=1.6×10⁴, Kᵢᵥ=390, mₚ=9.4×10⁻⁵, and similar values).

TABLE I
Inverter parameters

| Parameter | value | Parameter | value | Parameter | value |
|---|---|---|---|---|---|
| Kₚᵥ | 0.05 | K_{pc} | 10.5 | n_{q} | 1.4e−2 |
| K_{ic} | 1.6e4 | Kᵢᵥ | 390 | mₚ | 9.4e−5 |
| L_{f} | 0.00135 | wₙ | 314.15 | P_{ref} | 4400 |

In the foregoing, parameters of only one IBR are modeled by the neural network. It should be noted however, that some or all IBRs can be modeled as described herein. In certain implementations, one of the three inverters is modeled using a learned Port-Hamiltonian neural model while the others follow conventional control, and the resulting 3-bus network is subjected to fault and load-change scenarios to evaluate closed-loop performance.

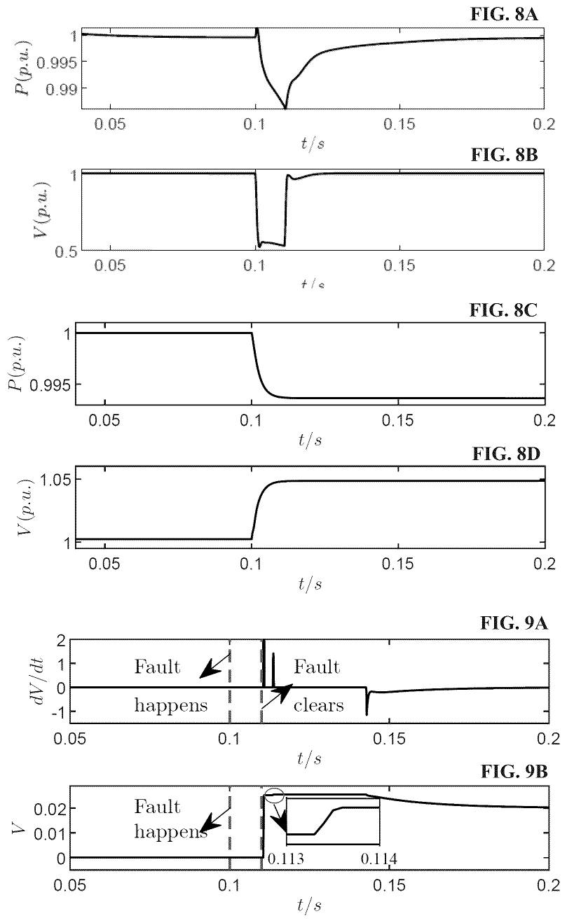

FIG. 8A and FIG. 8B respectively illustrate example active power and voltage curves of fault case in an example three-bus system. In particular, three IBRs interact in the closed-loop testing. As illustrated in FIG. 8A, upon occurrence of the fault the output active power P(p.u.) curve falls at about 0.1 s, and then gradually reaches a new steady state at about 0.2 s, as in secondary control, one of several control inputs is to modify the reference active power. Accordingly, after the fault clears, the system will arrive at a new reference value. The voltage V(p.u.) responds rapidly after the fault clears at 0.11 s. As illustrated in FIG. 8B, a similar trend is observed in the voltage curve as in the active power curve.

FIG. 8C and FIG. 8D illustrate a respective load change for the active power and voltage of the fault case in the three bus-system, as illustrated in FIGS. 8A and 8B. It is worth noting that the load in FIG. 8D for the voltage in FIG. 8B has increased to 120% after the fault clears. During testing, the voltage stabilizes at a different reference value, leading to a corresponding shift in its steady-state behavior. It should be noted that this shift is undesirable, as it is desirable that the system continue following an original reference value. This issue will be discussed in the following description.

FIG. 9A and FIG. 9B illustrate an example Lyapunov function of the foregoing three-bus system. In particular, when the fault clears at about 0.11 s, at 0.1132 s-0.1135 s, a small bump appears in the Lyapunov function, causing a brief positive dV/dt, as particularly illustrated in FIG. 9A. After the illustrated bump, voltage V in FIG. 8B remains strictly positive and dV/dt in FIG. 8A becomes strictly negative, indicating that the foregoing system has entered a stable region. It should be noted that the neural controller takes 0.0035 s to respond and restore post-fault stability to the system.

In accordance with (b)(2), the Hamiltonian GFM^{H} neural control is tested via multiple tests on a 37-bus, 6-subsystem (6-SS) power grid (not shown). In the tests, load changes ranging from 80% to 122%, occur randomly at one of four different locations. In fault scenarios, a fault is introduced at a random node and lasts for 0.05 s. The network consists of two hidden layers, each with 64 neurons. Key GFM parameters the grid-forming controller GFM are listed immediately below in Table II.

TABLE II
GFM parameters

| Parameter | Value | Parameter | Value | Parameter | Value |
|---|---|---|---|---|---|
| Kₚᵥ | 0.05 | K_{pc} | 10.5 | Kₚ | 0.004 |
| mₚ | 0.003 | K_{q} | 0.01 | n_{q} | 0.004 |
| α | 4 | β | 4 | Qₙ | 1000 |
| Vₙ | 311 | L_{f} | 0.00135 | wₙ | 314.15 |
| Q_{ref1} | 14.58e3 | Q_{ref2} | 13.76e3 | Q_{ref3} | 11.46e3 |

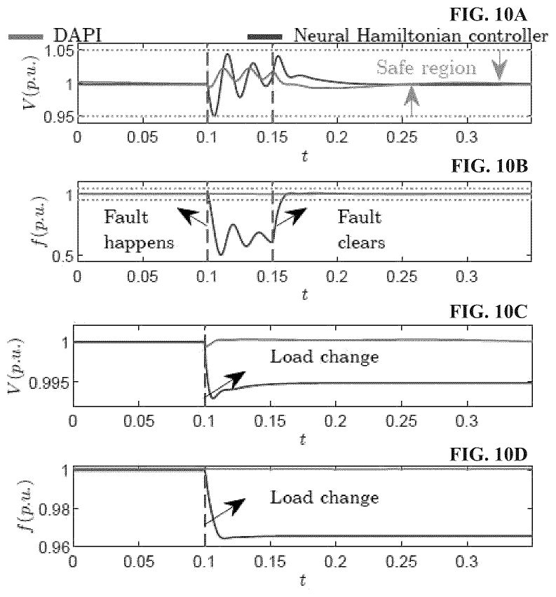

FIGS. 10A-10D illustrate a comparison of performance of an example neural GFM^{H} controller versus a standalone DAPI controller under a fault case as well as under a load change case, in each case for an example IBR in the foregoing 37-bus system.

In particular, FIGS. 10A and 10B illustrate the fault case. As particularly illustrated in FIG. 10A, the example GFM^{H} neural controller reaches a steady state in terms of a voltage V response earlier than the DAPI controller, whereas the DAPI-controlled system exhibits certain oscillations in frequency deviation. Moreover, when the fault has cleared and equilibrium states change, the standalone DAPI controller continues to encounter oscillations issues in f(p.u.) (e.g., represents a dimensionless normalization of a physical quantity like voltage, current, power, and/or impedance expressed as a per-unit value) within an observed time window, as particularly illustrated in FIG. 10B.

In the figures and descriptions, labels of the form (p.u.) indicate per-unit quantities. A per-unit value is obtained by normalizing a physical quantity by a chosen base value, rendering it dimensionless. For example, a per-unit frequency f(p.u.) may be defined as a ratio of actual system frequency to nominal base frequency (e.g., f(p.u.)=f_{actual}/f_{base}). Similarly, per-unit voltages V(p.iu.) and per-unit powers P(p.iu.) and Q(p.u.) are normalized by their respective base magnitudes. This normalization facilitates comparison across different operating conditions and systems.

Moreover, FIGS. 10C and 10D illustrate a load change case. It should be noted that FIGS. 10C and 10D shows the same traits as in FIGS. 8C and 8D. In particular, the system with a GFM^{H}r neural controller reaches a new steady state after the fault, as compared to the DAPI controller. This shift occurs because the primary objective during training is to maintain passivity and stability, while returning to the reference value is not explicitly included in the loss function. Accordingly, GFM^{H} neural controller can be combined with the DAPI controller for improved performance. Moreover, it should be noted that the foregoing methodology is flexible and can be adjusted by incorporating a different nominal controller than DAPI, such as for example, a PI controller.

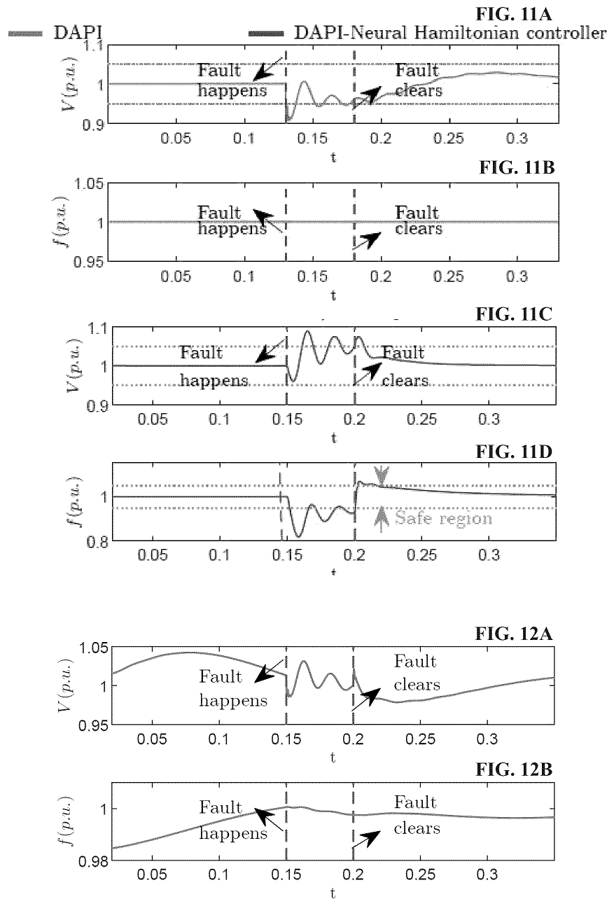

FIGS. 11A-11D illustrate a comparison of performance of a DAPI controller and a combined DAPI controller with the example neural GFM^{H} controller under a fault case, in each case for an example IBR in the foregoing 37-bus system.

In particular, FIGS. 11A and 11B illustrate voltage V and normalized f(p.u.) for the fault case using only the DAPI controller. When the fault clears, the DAPI-controller case takes approximately one additional second to settle the V, as particularly depicted in the FIG. 11A.

Moreover, FIGS. 11C and 11D illustrate voltage V and normalized f(p.u.) for the fault case using the combined DAPI controller with the example neural GFM^{H} controller. In particular, the combined controller responds more rapidly to faults. In comparison to the DAPI-only controller, the combined controller effectively resolves the divergence problem than the DAPI only controller, as evidenced by comparison of FIGS. 11A-B to FIGS. 11C-11D.

FIG. 12A and FIG. 12B illustrate performance under a fault case without use of any neural controller, in each case for an example LBR in the foregoing 37-bus system. In contrast, to the DAPI-only controller or the combined DAPI-neural GFM^{H} controller, the system clearly exhibits persistent oscillations and convergence difficulties throughout the simulation horizon, as particularly illustrated in FIGS. 12A and 12B.

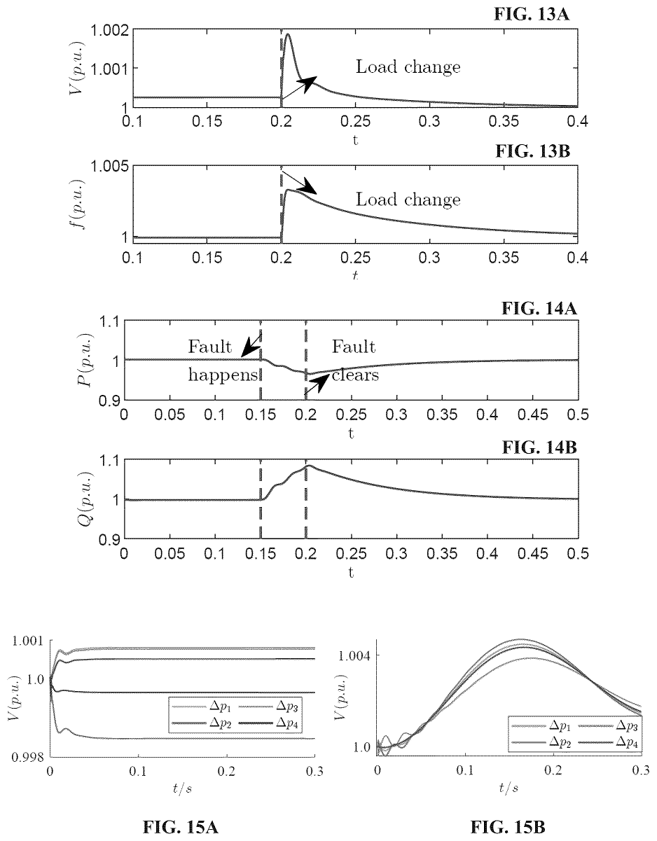

FIG. 13A and FIG. 13B illustrate voltage V and normalized per-unit frequency f(p.u.) value for the fault case using the combined DAPI controller with the example neural GFM^{H} controller, in each case for an example IBR in the foregoing 37-bus system. As particularly illustrated FIGS. 13A and 13B, the combined controller responds rapidly to faults and successfully returns to the reference V and f(p.u.) values, a significant improvement compared to the limitations observed in DAPI-only or no neural control cases.

In the 37-bus multi-IBR example illustrated in FIGS. 13A and 13B, a composite controller that includes a baseline GFM controller and a neural GFM^{H} controller drives the system back toward its reference operating point after occurrence of a disturbance. The voltage magnitudes and normalized frequency (or other related per-unit quantities) exhibit transient deviations during the fault or perturbation, but subsequently converge toward their pre-disturbance reference values under the action of the composite controller. This behavior contrasts with cases in which only the baseline controller or no neural controller is used, demonstrating that the composite controller which includes the neural GFM^{H} controller can maintain stability and reference tracking in a larger network.

FIG. 14A and FIG. 14B illustrate output active power P(p.u.) and reactive power Q(p.u.) using a combined DAPI-neural GFM^{H} controller, for an example IBR in the foregoing 37-bus system. The output active power P and reactive power Q are shown to visualize their changes during and after the fault. As the combined controller outputs secondary control inputs, as set forth hereinabove in Equation (13), stability is maintained without deviating from the original reference value. This is evident as the P and Q curves return to their initial states.

FIG. 15A and FIG. 15B illustrate voltage V using different control methods (controllers) with an uncertainty Δp, for an example IBR in the foregoing 37-bus system. In particular, FIG. 15A illustrates the voltage as a result of the combined DAPI—neural GFM^{H} controller, while 15B illustrates the voltage using a DAPI controller without the neural GFM^{H} controller.

Additionally to its sensitivity to initial conditions, a DAPI controller exhibits high sensitivity to hyperparameter settings. As depicted in FIG. 15B, uncertainty Δp, uniformly distributed within −15% to +10% of the original reference P, is added to P*, as defined in Equation (13).

In robustness tests, the active-power reference is perturbed so as to emulate uncertainty and varying operating conditions. For a nominal active power reference P*, an uncertainty term Δp is drawn from a uniform distribution within −15% to +10% of P*. The perturbed reference used by the controller is then, P_{ref}=P*+Δp, so that P_{ref} may be as low as 85% or as high as 110% of the nominal value. This construction evaluates the controller's ability to maintain stability and performance under realistic variations in power setpoints.

As illustrated in FIG. 15A, the performance of the combined DAPI-neural GFM^{H} controller, quickly stabilize the voltage despite different uncertain initial values. Whereas FIG. 15B shows that under the same uncertainty Δp, the voltage of the IBR, when controlled solely by the DAPI controller, exhibits oscillations after introducing the uncertainty, similar to those exhibited in FIGS. 12A and 12B. This reveals that using only the DAPI controller makes the system highly sensitive to initial conditions and parameter changes. By incorporating the proposed neural GFM^{H} controller, the system achieves faster convergence and improved resilience.

### Real-World Application

In real-world scenarios, the objective of introducing a neural controller is not to entirely replace the classical control architecture, but rather to serve as an additional layer that enhances passivity and improves system stability.

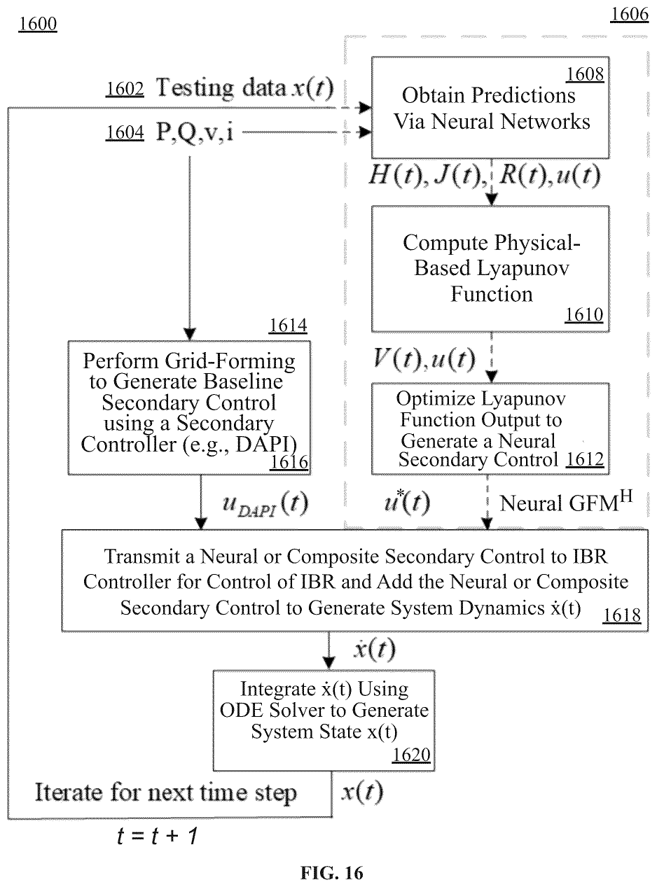

FIG. 16 illustrates an example composite controller 1600 including a classical grid-forming controller 1614 and its methodology combined with a neural GFM^{H} controller 1606 and its methodology as described herein, with the composite controller capable of forming a secondary control for an IBR controller 502 to control an associated IBR on a power distribution system 200, as illustrated in FIG. 5. For example, the composite controller 1614 can include a DAPI controller or a PI controller.

The classical grid-forming controller 1614 receives current values for measured power parameters 1604 related to the IBR on the power distribution system 200, for example, values including P, Q, v, i, etc. The neural GFM^{H} controller further receives system state x(t) 1602 of a previous time step, as well as the current value for the measured power parameter values 1604. If it is a first time step (e.g., t=0), the system state x(t) can be obtained from simulation or measurement, wherein for a successive time step the system state is computed during a preceding time step and is received as input.

The overall architecture of the composite controller 1600 includes two parallel components: (a) a left loop of a classical grid-forming controller 1614 (e.g., DAPI or PI), and (b) a right loop of the neural GFM^{H} controller 1606, which is a parallel neural layer of provided by GFM^{H} controller 1606. Working together, these two control loops generate a system response and predict system state x(t) used for a next time step (e.g., t=t+1). The predicted system state x(t) is then fed as a new input 1602 for the next time step, and the processing is iterated sequentially over time.

In the right loop, at operation 1608, the neural GFM^{H} controller 1606 uses received system received dynamics x(t) 1602 and measured power parameter values 1604 to obtain predicted variables H(t),J(t), R(t), and u(t) via neural networks 304, 306, as particularly illustrated in FIG. 3. A physically-based Lyapunov function embedded in the neural networks is used to compute variables V(t) and u(t). The output of the Lyapunov function is then used to optimize the variable u(t) and generate a secondary neural control u*(t).

In the left loop, at operation 1616, the classical grid-forming controller 1614 performs grid-forming to generate a baseline secondary control u_{DAPI}(t) based on the received measured power parameter values 1602. Thereafter, at operation 1618, the classical grid-forming controller 1614 combines secondary classical control u_{DAPI}(t) and secondary neural control u*(t) into a composite control u, which is then transmitted to an IBR controller 502 for control of an LBR on the power distribution network 200. Moreover, the composite control u is added in when generating a derivate of the system dynamics \dot{x}(t). Lastly, at operation 1620, a derivate of the system dynamics \dot{x}(t) is then solved using an ODE solver to generate a system state x(t). This system state x(t) is then used as input when iterating the right loop of the composite controller for a next time step t=t+1.

It might be desirable to use only neural GFM^{H} controller 1606. In such cases, only the operations 1608-1612 of right loop are performed, wherein the right loop also includes operations 1618 and 1620. In operation 1618, the neural GFM^{H} controller 1606 transmits the secondary neural control u*(t) to the IBR controller 502 for control of an IBR on the power distribution network 200, and the secondary control u*(t) is added in when generating a derivate of the system dynamics k(t). At operation 1620, the derivate of the system dynamics x(t) is then integrated using an ODE solver to generate a system state x(t). Thereafter, the system state x(t) is used as input when iterating the left and right loops of the composite controller for a next time step t=t+1.

It should be noted that if the power distribution system 200 experiences critical changes such that the underlying physics might be altered (e.g., a significant parameter drift or operating conditions beyond the learned domain), the neural GFM^{H} controller 1606 should be re-trained as illustrated in FIG. 3. The training process can also be implemented to periodically update a neural GFM^{H} controller 1606. In some cases, training can be done online by using real-time data for the system, such as power distribution system 200. From a manufacturer's perspective, the neural GFM^{H} controller 1606 can be embedded as a neural control layer directly into a converter control module, alongside a conventional controller, such as DAPI, PI, etc.

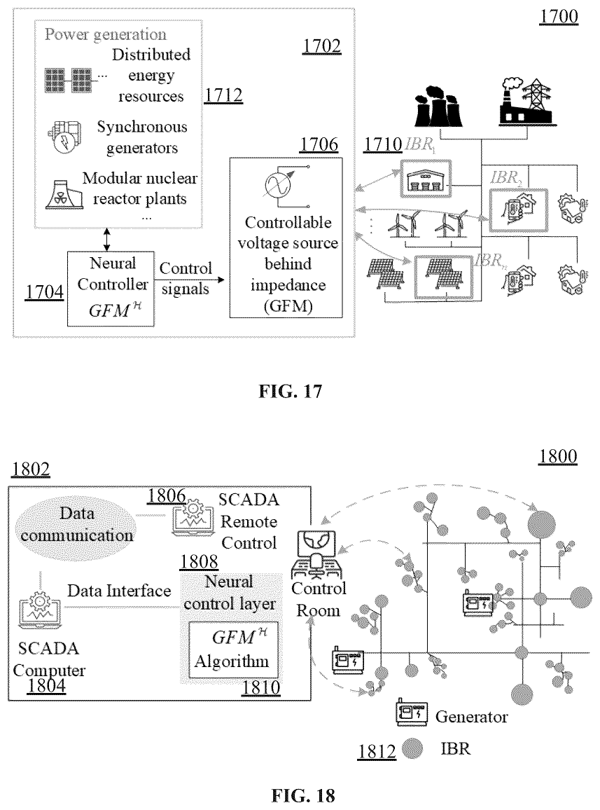

FIG. 17 illustrates an example neural GFM^{H} controller 1704 distributed locally in an example IBR 1710 of an example power distribution system 1700. In particular, the neural GFM^{H} controller 1704 can be embedded directly into, or generally associated with, a converter control module 1702 of the example IBR 1710. The power distribution system 1700 can include one or more IBRs (e.g., IBR₁-IBRₙ), and additional neural GFM^{H} controllers can similarly be deployed locally in association with those IBRs (e.g., embedded into control modules of the IBRs).

The converter control module 1702 includes a primary grid-forming module (GFM) 1706 that controls power electronics (voltage source) of the IBR in converting DC to AC. An example of the primary GFM power electronics for controlling an IBR voltage source is illustrated as the IBR controller 502 in FIG. 5. Typically, the GFM 1706 utilizes a cascaded loop structure to regulate voltage, frequency, and power of the IBR 1710 using primary control signals. The neural GFM^{H} controller 1702 generates secondary control signals that are provided to the GFM 1706. In operation, the GFM 1796 combines primary control signals and the secondary control signal in regulating the voltage, frequency, and power of the IBR 1710.

In the foregoing framework, individual neural GFM^{H} controllers can be independently trained and locally implemented in the IBRs of the power distribution 1700. In this regard, it should be recalled that a key property of passivity is compositionality, that is, when a passive subsystem is interconnected with other passive components, the overall system remains passive. Accordingly, a total Hamiltonian function H can be expressed as the sum of the Hamiltonians of all passive systems and components. In view of the foregoing, each local IBR can thus be equipped with built-in passivity and stability through the embedded GFM^{H} controller 1704.

FIG. 18 illustrates an example neural GFM^{H} controller 1810 deployed in a neural control layer 1808 of an example control facility 1802 (e.g., a control room), remotely from an example IBR 1812 in an example power distribution system 1800.

A supervisory control and data acquisition (“SCADA”) remote controller 1806 remotely controls the IBR 1812 (as well as other IBRs) in the power distribution system 1800, such as via classical secondary control (e.g., DAPI, PI, etc.), communicating control signals to the IBRs remotely via a communication network (e.g., Internet, WAN, LAN, mobile network, satellite network, and/or a combination of various networks).

The neural control layer 1808 interfaces its neural GFM^{H} controller 1810 with a SCADA computer 1804 via a data interface, so that neural GFM^{H} controller 1810 can communicate secondary control signals for the IBR 1812 to the SCADA remote controller 1806 via a SCADA computer 1804, which is connected with the SCADA remote controller via a data communication network.

From a utility's perspective, the neural GFM^{H} controller 1810 can be deployed in a centralized architecture (e.g., within the control room), remotely from the IBRs of the power distribution system 1800. In this context, the power distribution system 1800 is treated as a grey-box. Unlike black-box training, grey-box training incorporates physical structure and system constraints into the learning process, ensuring that the neural networks of the neural GFM^{H} controller 1810 conform to the port-Hamiltonian formulation, as described hereinabove.

### CONCLUSION

The foregoing establishes a Hamiltonian grid-forming framework and control resulting in neural GFM^{H} controller that inherently ensures scalability, stability, and passivity of inverter-based resources (IBRs) on IBR-rich grids and/or microgrids. This inventive neural controller methodology has been tested in both forced and unforced systems. The neural GFM^{H} controller can be used independently or can be combined with other controllers, such as secondary DAPI or PI controller, into an efficient neural layer. This framework enables stable plug-and-play integration of IBRs under uncertainties, avoiding prohibitively expensive re-tuning of IBRs and making advanced system-level grid-forming functionalities immediately achievable.

Harnessing the resilience benefits of IBRs requires grid-forming inverters to be highly stable and flexible. The increased complexity, uncertainties, and nonlinearities in IBRs-rich power systems have introduced significant challenges for traditional control methods. To address this, a physics-aware neural Grid-Forming Hamiltonian (GFM^{H}) approach and controller were established, leveraging the Port-Hamiltonian formalism of power systems while ensuring guaranteed passivity through machine learning. From the learned model, a candidate Lyapunov function is derived to facilitate stability analysis. Built on this, an enhanced composite controller is devised, integrating the neural GFM^{H} control with a system's baseline control, e.g., DAPI or PI. This approach combines the steady-state reference convergence property of PI control with the robustness and stability guarantees of neural control. Further, the compositional properties inherent to passive systems enable distributed learning, significantly improving efficiency as well as large-scale plug-and-play deployment of the new methodology. Extensive test cases of both forced and unforced systems were provided to validate the effectiveness and efficacy of neural GFM^{H} methodology and control across various scenarios, alone as well as in combination with other neural control, e.g., DAPI or PI.

Therefore, there has been described a grid-forming Port-Hamiltonian framework (GFM^{H}) that models the system in a PH format using lightweight neural networks. It enables a simultaneous computation of Lyapunov-certified control policies with built-in passivity and stability guarantees in dynamic, evolving systems, supporting plug-and-play operations. By incorporating Lyapunov-certified control policies with classical control mechanisms, the neural GFM^{H} methodology ensures both closed-loop stability and convergence to the desired reference values, thereby addressing the missing links in existing model-driven and learning-based approaches.

In sum, the contributions of the foregoing neural GFM^{H} controller are threefold:
It establishes Hamiltonian neural networks for ensuring the passivity of subsystems so that the passivity of the whole system is provably guaranteed;
The learned networks are further optimized so that controls resultant from these trained neural networks are able to ensure both Lyapunov stability and Hamiltonian passivity in power grids under uncertainties and contingencies; and
The passivity- and stability-provisioning of the neural networks are fused with IBRs' grid-forming controls, which leads to neural GFM^{H} capabilities in the grids.

The foregoing provides a step towards a scalable control solution that balances the strengths of neural and classical control methodologies. Through theoretical analysis and simulation, there was demonstrated efficacy of inventive neural GFM^{H} methodology in helping to address scalability, stability, and passivity challenges in complex systems related to IBR-rich power grids and microgrids.

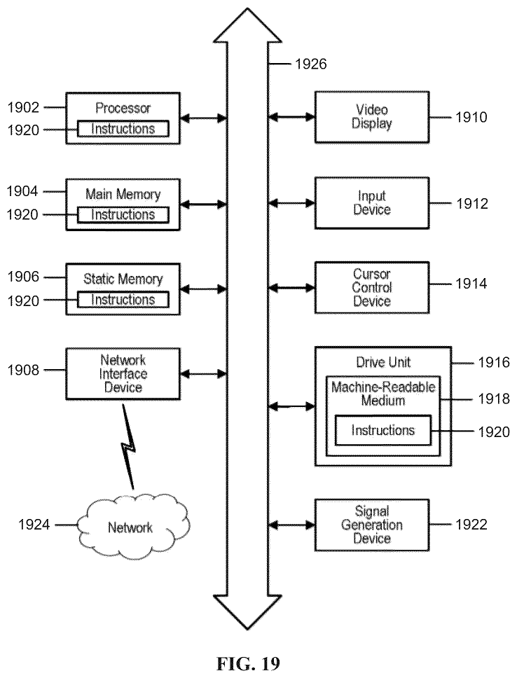

FIG. 19 is a block diagram of an illustrative embodiment of a general computer system 1900. The computer system 1900 can include a set of instructions that can be executed to cause the computer system 1900 to perform any one or more of the methods or computer based functions disclosed herein in FIGS. 1-18. The computer system 1900, or any portion thereof, may operate as a standalone device or may be connected, e.g., using a network or other connection, to other computer systems or peripheral devices.

The computer system 1900 may be any one of the electronic devices, or integrated into any one of the electronic components, as described herein. The computer system 1900 may also be implemented as or incorporated into various devices, such as a personal computer (PC), a tablet PC, a personal digital assistant (PDA), a computing device or mobile device (e.g., smartphone), a palmtop computer, a laptop computer, a desktop computer, a communications device, a control system, a web appliance, or any other machine capable of executing a set of instructions (sequentially or otherwise) that specify actions to be taken by that machine. Further, while a single computer system 1500 is illustrated, the term “system” shall also be taken to include any collection of systems or sub-systems that individually or jointly execute a set, or multiple sets, of instructions to perform one or more computer functions.

As illustrated in FIG. 19, the computer system 1900 may include a processor 1902, e.g., a central processing unit (CPU), a graphics-processing unit (GPU), or both. Moreover, the computer system 1900 may include a main memory 1904 and a static memory 1906 that can communicate with each other via a bus 1926. As shown, the computer system 1900 may further include a video display unit 1910, such as a liquid crystal display (LCD), an organic light emitting diode (OLED), a flat panel display, a solid state display, a cathode ray tube (CRT), or another video display unit. Additionally, the computer system 1900 may include an input device 1912, such as a keyboard, and a cursor control device 1914, such as a mouse. The computer system 1900 can also include a disk drive (or solid state)unit 1916, a signal generation device 1922, such as a speaker or remote control, and a network interface device 1908.

In a particular embodiment or aspect, as depicted in FIG. 19, the disk drive (or solid state)unit 1916 may include a computer-readable medium 1918 in which one or more sets of instructions 1920, e.g., software, can be embedded. Further, the instructions 1920 may embody one or more of the methods or logic as described herein. In a particular embodiment or aspect, the instructions 1920 may reside completely, or at least partially, within the main memory 1904, the static memory 1906, and/or within the processor 1902 during execution by the computer system 1900. The main memory 1904 and the processor 1902 also may include computer-readable media.

In an alternative embodiment or aspect, dedicated hardware implementations, such as application specific integrated circuits, programmable logic arrays, and/or other hardware devices, can be constructed to implement one or more of the methods described herein. Applications that may include the apparatus and systems of various embodiments or aspects can broadly include a variety of electronic and computer systems. One or more embodiments or aspects described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments or aspects, the methods described herein may be implemented by software programs tangibly embodied in a processor-readable medium and may be executed by a processor. Further, in an exemplary, non-limited embodiment or aspect, implementations can include distributed processing, component/object distributed processing, and parallel processing. Alternatively, virtual computer system processing can be constructed to implement one or more of the methods or functionality as described herein.

It is also contemplated that a computer-readable medium includes instructions 1920 or receives and executes instructions 1920 responsive to a propagated signal, so that a device connected to a network 1924 can communicate voice, video or data over the network 1924. Further, the instructions 1920 may be transmitted or received over the network 1924 via the network interface device 1908.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, example embodiment or aspect, the computer-readable medium can include a solid-state memory, such as a memory card or other package, which houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals, such as a signal communicated over a transmission medium. A digital file attachment to an e-mail or other self-contained information archive or set of archives may be considered a distribution medium that is equivalent to a tangible storage medium. Accordingly, any one or more of a computer-readable medium or a distribution medium and other equivalents and successor media, in which data or instructions may be stored, are included herein.

In accordance with various embodiments or aspects, the methods described herein may be implemented as one or more software programs running on a computer processor. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, a tangible storage medium or distribution medium as listed herein, and other equivalents and successor media, in which the software implementations herein may be stored, are included herein.

There have thus been described system and method of grid-forming Hamiltonian control in IBR-rich grids enabling scalability, stability, and passivity. Although specific example embodiments or aspects have been described, it will be evident that various modifications and changes may be made to these embodiments or aspects without departing from the broader scope of the invention. Accordingly, the specification and drawings are to be regarded in an illustrative rather than a restrictive sense. The accompanying drawings that form a part hereof, show by way of illustration, and not of limitation, specific embodiments or aspects in which the subject matter may be practiced. The embodiments or aspects illustrated are described in sufficient detail to enable those skilled in the art to practice the teachings disclosed herein. Other embodiments or aspects may be utilized and derived therefrom, such that structural and logical substitutions and changes may be made without departing from the scope of this disclosure. This Detailed Description, therefore, is not to be taken in a limiting sense, and the scope of various embodiments or aspects is defined only by the appended claims, along with the full range of equivalents to which such claims are entitled.

Such embodiments or aspects of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments or aspects have been illustrated and described herein, it should be appreciated that any arrangement calculated to achieve the same purpose may be substituted for the specific embodiments or aspects shown. This disclosure is intended to cover any and all adaptations or variations of various embodiments or aspects. Combinations of the above embodiments or aspects, and other embodiments or aspects not specifically described herein, will be apparent to those of skill in the art upon reviewing the above description.

The Abstract is provided to comply with 37 CFR § 1.72(b) and will allow the reader to quickly ascertain the nature and gist of the technical disclosure. It is submitted with the understanding that it will not be used to interpret or limit the scope or meaning of the claims.

In the foregoing description of the embodiments or aspects, various features are grouped together in a single embodiment for the purpose of streamlining the disclosure. This method of disclosure is not to be interpreted as reflecting that the claimed embodiments or aspects have more features than are expressly recited in each claim. Rather, as the following claims reflect, inventive subject matter lies in less than all features of a single disclosed embodiment or aspect. Thus, the following claims are hereby incorporated into the Detailed Description, with each claim standing on its own as a separate example embodiment or aspect. It is contemplated that various embodiments or aspects described herein can be combined or grouped in different combinations that are not expressly noted in the Detailed Description. Moreover, it is further contemplated that claims covering such different combinations can similarly stand on their own as separate example embodiments or aspects, which can be incorporated into the Detailed Description.

1. A system to control an inverter-based resource (IBR) on a power distribution network, the system comprising:
a processing device; and
a memory storing instructions that, when executed by the processing device, cause the processing device to execute operations comprising:
receiving as input measured input power parameters for a current time step and input system state related to the IBR as calculated for a previous time step, wherein the input system state is simulated or measured when the current time step is a first time step and there is no previous time step;
processing the input power parameters and the input system state using a neural Port-Hamiltonian controller, comprising trained neural networks with an embedded Lyapunov function which includes physical constraints of the power distribution network, to generate prediction outputs including a Hamiltonian function, several structure matrices, and a neural secondary control; and
executing the Lyapunov function based on the Hamiltonian function and the neural secondary control that satisfies the physical constraints, wherein the IBR is capable of being controlled using an output secondary control based at least on the neural secondary control, ensuring passivity and stability of the power distribution network.

2. The system of claim 1, wherein the operations comprise transmitting the neural secondary control as the output secondary control to an IBR controller, the IBR controller being configured to control the IBR based on a primary control generated by the IBR controller and the neural secondary control.

3. The system of claim 1, wherein the operations comprise:
optimizing the neural secondary control to an optimized neural secondary control; and
transmitting the optimized neural secondary control as the output secondary control to an IBR controller, the IBR controller being configured to control the IBR based on a primary control generated by the IBR controller and the optimized neural secondary control.

4. The system of claim 3, wherein the neural secondary control is optimized using Gurobi optimization to form the optimized neural secondary control.

5. The system of claim 1, wherein the operations further comprise:
generating a derivative of system dynamics for the current time step based on the prediction outputs; and
integrating the derivative to generate an output system state to be used as the input for a next time step.

6. The system of claim 5, wherein the operations comprise iterating receiving, processing, and executing for the next time step.

7. The system of claim 1, wherein the operations comprise:
processing the input power parameters using a baseline controller to generate a baseline secondary control for the IBR; and
generating the output secondary control as a composite secondary control based on the neural secondary control and the baseline secondary control.

8. The system of claim 7, wherein the operations further comprise:
generating a derivative of system dynamics for the current time step based on the prediction outputs, wherein the neural secondary control is the composite secondary control; and
integrating the derivative to generate an output system state of to be used as the input for a next time step.

9. The system of claim 8, wherein the operations comprise iterating receiving, processing, and executing for the next time step.

10. The system of claim 1, wherein the power parameters received as the input include at least active power, reactive power, voltage, and current.

11. A method of controlling an inverter-based resource (IBR) on a power distribution network, the method comprising:
receiving as input measured input power parameters for a current time step and an input system state related to the IBR as calculated for a previous time step, wherein the input system state is simulated or measured when the current time step is a first time step and there is no previous time step;
processing the input power parameters and the input system state using a neural Port-Hamiltonian controller, comprising trained neural networks with an embedded Lyapunov function which includes physical constraints of the power distribution network, to generate prediction outputs including a Hamiltonian function, several structure matrices, and a neural secondary control; and
executing the Lyapunov function based on the Hamiltonian function and the neural secondary control that satisfies the physical constraints, wherein the IBR is capable of being controlled using an output secondary control based at least on the neural secondary control, ensuring passivity and stability of the power distribution network.

12. The method of claim 11, wherein the method further comprises transmitting the neural secondary control as the output secondary control to an IBR controller, the IBR controller being configured to control the IBR based on a primary control generated by the IBR controller and the neural secondary control.

13. The method of claim 11, wherein the method further comprises:
optimizing the neural secondary control to an optimized neural secondary control; and
transmitting the optimized neural secondary control as the output secondary control to an IBR controller, the IBR controller being configured to control the IBR based on a primary control generated by the IBR controller and the optimized neural secondary control.

14. The method of claim 13, wherein the neural secondary control is optimized using Gurobi optimization to form the optimized neural secondary control.

15. The method of claim 11, wherein the method further comprises:
generating a derivative of system dynamics for the current time step based on the prediction outputs; and
integrating the derivative to generate an output system state to be used as the input for a next time step.

16. The method of claim 15, wherein the method further comprises iterating receiving, processing, and executing for the next time step.

17. The method of claim 11, wherein the method further comprises:
processing the input power parameters using a baseline controller to generate a baseline secondary control for the IBR; and
generating the output secondary control as a composite secondary control based on the neural secondary control and the baseline secondary control.

18. The method of claim 17, wherein the method further comprises:
generating a derivative of system dynamics for the current time step based on the prediction outputs, wherein the neural secondary control is the composite secondary control; and
integrating the derivative to generate an output system state to be used as the input for a next time step.

19. The method of claim 18, wherein the operations comprise iterating receiving, processing, and executing for the next time step.

20. The method of claim 11, wherein the power parameters received as the input include at least active power, reactive power, voltage, and current.
